(19) United States
(12) Patent Application Publication
(10) Pub. No.: US 2018/0039679 A1
(43) Pub. Date: Feb. 8, 2018

(54) INTEGRATED MANAGEMENT OF DISPARATE DATA FROM ISOLATED DATA SOURCES

(71) Applicant: Exhaustless, Inc., Ann Arbor, MI (US)

(72) Inventor: Steven P. Endres, Ann Arbor, MI (US)

(21) Appl. No.: 15/789,585

(22) Filed: Oct. 20, 2017

Related U.S. Application Data
(63) Continuation-in-part of application No. 15/241,230, filed on Aug. 19, 2016.
(60) Provisional application No. 62/209,226, filed on Aug. 24, 2015.

(51) Int. Cl. G06F 17/30; G06Q 10/10; G06Q 10/04; G06Q 30/02; G06Q 10/06; G06Q 10/02

(52) U.S. Cl. CPC G06F 17/30557; G06Q 10/06375; G06Q 10/06393; G06Q 10/025; G06Q 10/04; G06Q 30/0283; G06Q 10/109

(57) ABSTRACT

Embodiments of the disclosed technology involve an integration system configured to integrate disparate data sources retrieved from an air traffic server and a ticket vendor server. An air traffic server and a ticket vendor server can be iteratively queried. An integrated dataset can be generated by identifying segment associated with a slot and mapping the identified segments. A congestion delay can be determined based on the integrated dataset. A congestion delay target based on an estimated time value of a plurality of passengers may be selected by identifying a convergence between an estimated yield loss from reducing the number of flights and the estimated value of time for the plurality of passengers. A utilization level of the slot may be determined based on the selected congestion delay target.

### CROSS-REFERENCE TO RELATED APPLICATIONS

This application is a continuation-in-part of U.S. patent application Ser. No. 15/241,230, titled “SYSTEM AND METHOD FOR MANAGING AIR TRAFFIC DATA” and filed on Aug. 19, 2016, which claims the benefit of U.S. Patent Provisional Application No. 62/209,226, titled “CONGESTION MANAGEMENT PROCESS AND METHODS” and filed on Aug. 24, 2015, which are incorporated herein in their entirety by this reference thereto.

### TECHNICAL FIELD

The present application is related to data management systems, and more specifically to methods and systems of integrated management of disparate data from isolated data sources.

### BACKGROUND

Data resource management involves developing and executing architectures, policies, practices, and procedures that properly manage a full data lifecycle that enhance the value of data and information assets. A disparate system or a disparate data system includes computer data processing systems designed to operate as a fundamentally distinct data processing system without exchanging data or interacting with other computer data processing systems. A disparate system is often characterized as an information silo because of the data system's isolation from or incompatibility with any other data systems.

An information silo, or a group of such silos, is an insular management system in which one information system or subsystem is incapable of reciprocal operation with others that are, or should be, related. Thus information is not adequately shared but rather remains sequestered within each system or subsystem, figuratively trapped within a container like grain is trapped within a silo.

### SUMMARY

Certain aspects of the invention involve integrating disparate data sources retrieved from an air traffic server and a ticket vendor server to derive air traffic insights. An integrated management server can be employed to extract, transform, and load data from heterogeneous sources into a single view schema so data from different sources become compatible.

### BRIEF DESCRIPTION OF THE DRAWINGS

FIG. 1 is a block diagram illustrating an integrated management system, according to various embodiments.

FIG. 2A is a block diagram illustrating a control server, according to various embodiments.

FIG. 2B is a block diagram illustrating components of the integrated management system, according to various embodiments.

FIG. 2C is a block diagram illustrating disparate data retrieved from disparate data sources, according to various embodiments.

FIG. 3 is a graphical illustration of a control server performing a method, according to various embodiments.

FIG. 4A is a graphical illustration of the control server providing congestion premium data to a graphical user interface, according to various embodiments.

FIG. 4B is a flow diagram illustrating a method of determining an estimated congestion delay function, according to various embodiments.

FIG. 4C is a simplified illustration of a congestion delay function determined through regression analysis, according to various embodiments.

FIG. 4D is a simplified illustration of a ticket acquisition function determined through regression analysis, according to various embodiments.

FIG. 5 is a flow diagram illustrating a sample process for managing air traffic congestion, according to various embodiments.

FIGS. 6A-6B are a flow diagram illustrating another sample process for managing air traffic congestion, according to various embodiments.

FIG. 7A illustrates taxi time functions for a runway having three configurations, according to various embodiments.

FIG. 7B illustrates a deviation between a taxi time function and an unimpeded function, according to various embodiments.

FIG. 7C illustrates a taxi time functions for a runway having three configurations, according to various embodiments.

FIG. 8 is a flow diagram illustrating a sample process for computing airport usage polynomials, according to various embodiments.

FIG. 9 is a flow diagram illustrating a sample process for generating airport delay polynomial tables, according to various embodiments.

FIG. 10 is a flow diagram illustrating a sample process for extracting delay data associated with a cause category, according to various embodiments.

FIG. 11 is a flow diagram illustrating a sample process for computing a maximum slot limit, according to various embodiments.

FIG. 12 is a flow diagram illustrating a sample process for computing limits for a delay function, according to various embodiments.

FIG. 13 is a diagrammatic representation of a machine in the example form of a computer system within which a set of instructions, for causing the machine to perform any one or more of the methodologies or modules discussed herein, may be executed.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

Certain aspects of the technology disclosed involve integrated management of disparate data from isolated data sources. Application integration is an integration framework composed of a collection of technologies and services which form a middleware or “middleware framework” to enable integration of systems and applications. The various systems that need to be linked together may reside on different operating systems, use different database solutions or computer languages, or different date and time formats, or may be legacy systems that are no longer supported by the vendor who originally created them. In some cases, such systems include components compiled in a way that makes modification challenging.

Disparate systems can be located, for example, in a legacy aviation server and a ticket vendor server. The aviation server can include a technical architecture, application architecture, and/or data architecture that is incompatible with the ticket vendor server. Likewise, the ticket vendor server can include a technical architecture, application architecture, and/or data architecture incompatible with the aviation server.

An integrated management system can be employed to extract, transform, and load data from heterogeneous sources into a single view schema so data from different sources become compatible. For instance, the integrated management server retrieves incompatible data from the aviation server and the ticket vendor server. The integrated management server transforms retrieved data into a compatible format to enable large-scale data integration. Integrated data from previously disparate data sources can be analyzed to glean insights that would not be possible without the integration of the disparate data sources.

Embodiments of the disclosed technique can integrate disparate data sources retrieved from an aviation server and a ticket vendor server to derive air traffic insights not previously performable by a computing device. In an embodiment, an airport congestion management method and system can be used to reduce congestion delays. Embodiments include querying an air traffic database for air traffic data of an airport including schedules of a number of flights utilizing a slot of the airport. A slot may be a period of time for an aircraft to take-off or land at the airport. A congestion delay resulting from the number of flights utilizing the slot of the airport may be determined based on the air traffic data. A congestion delay target based on an estimated time value of a plurality of passengers may be selected. A utilization level of the slot may be determined based on the selected congestion delay target. A premium schedule database may be updated to allocate the congestion premium among tickets for one or more flights scheduled during the slot. The congestion premium may be provided to a ticket vendor server.

Embodiments may reduce congestion delays by altering passenger ticket selection patterns to conform to a determined utilization level of a runway for a period of time (e.g., a slot utilization level). Embodiments include obtaining ticket acquisition data over a time period from a ticket vendor server and reevaluating the congestion premium for the one or more flights scheduled during the slot based on the ticket acquisition data. The premium schedule database may be updated with the reevaluated congestion premium. The reevaluated congestion premium may be provided to the ticket vendor server.

A slot may be a half-hour time span in which an aircraft may be permitted to conduct a flight. Slots may be associated with an airline, airport, and time range. An airline may have a right to operate a flight in a slot. An airline may forfeit a right to operate a flight in a slot. For example, an airline may fail to operate a flight in a slot resulting in forfeiture. In another example, a number of passengers on flights in a slot (e.g., 11:00 am-11:30 am slot) may fall below a threshold (e.g., fifty percent) for a designated number of times (e.g., four consecutive days) resulting in forfeiture. In another example, an airline may elect to forfeit a slot (e.g., if ticket purchases fall below a threshold for a flight in a slot).

A number of flights within any time slot must be less than the maximum capacity of the airport. A congestion delay may be determined based on a number of flights utilizing a particular slot. A non-congestion related delay can include random variation in process times caused by, for example, weather, personnel delays, mechanical malfunctions, etc. Slot management may include controlling the number of flights per slot to reduce a congestion delay resulting from the number of flights utilizing a slot of an airport. A number of flights per slot may be reduced by disincentivizing ticket purchases for flights in the slot with a congestion premium.

Congestion premiums may allow operational flexibility to meet flight-to-flight challenges while disincentivizing chronic congestion delays. Enacting congestion management may reduce a number of slots available for flights. Competition between passengers for peak-time service may increase as slots are taken out of service. Passengers willing to pay more for peak-time service may pay a congestion premium that may collect into an account specifically targeted to improving service at an airport. Some slots may be returned to service and some slots may be created from increased flight volume at non-congested times or from expanded flight capacity created from new airport infrastructure.

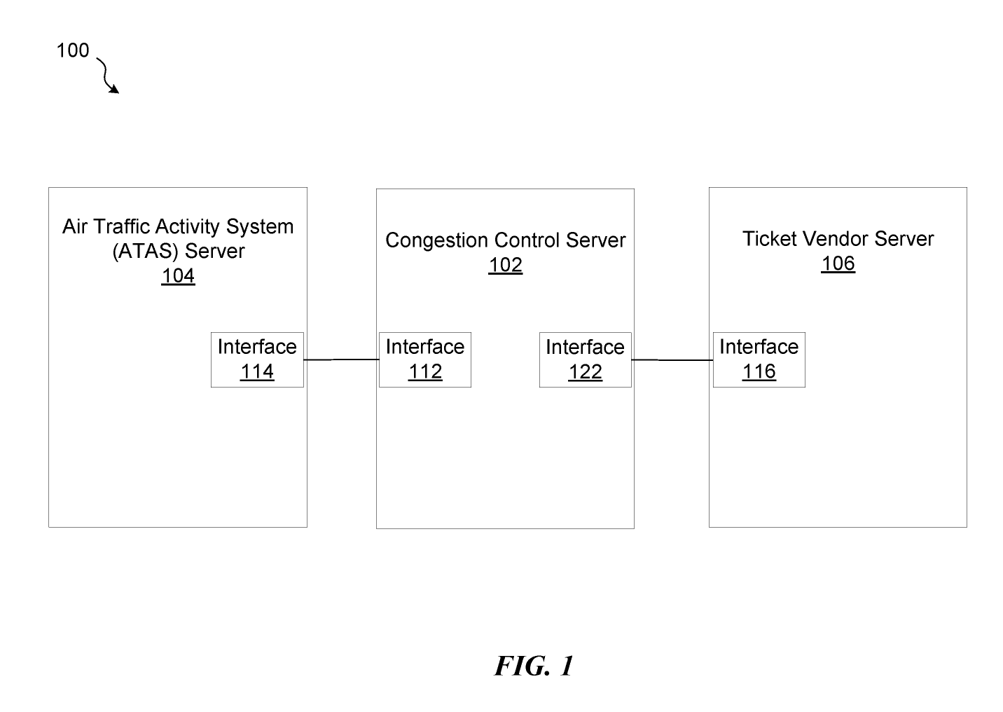

FIG. 1 is a block diagram illustrating an integrated management system 100, according to various embodiments. The integrated management system 100 may include an air traffic activity system (ATAS) server 104, control server 102, and ticket vendor server 106.

The ATAS server 104 may contain air traffic operation data available for public or non-public release. The ATAS server 104 may be operated by the Federal Aviation Administration. The ATAS server 104 may contain data associated with historical, current, or future air traffic operations (e.g., scheduled air traffic data), or any combination of historical, current, or future air traffic operations. The air traffic operation data may include information regarding a plurality of flights utilizing a plurality of slots at a plurality of airports. For example, the air traffic operation data may indicate that six flights utilized a slot (e.g., 10:00 am-10:30 am slot) of runway 13R-31L at John F. Kennedy International Airport on Aug. 1, 2015. The ATAS server 104 may include an interface 114 configured to communicate with an interface 112 of the control server 102. The ATAS server 104 may provide air traffic operation data to the control server 102 by utilizing interface 114 to communicate the air traffic operation data to interface 112.

Ticket vendor server 106 may contain ticket data for public or non-public release. The ticket vendor server 106 may be operated by, for example, an airline or a third-party ticket vendor. The ticket data may include a number of tickets available for a number of flights, a number of tickets sold for a number of flights, a price of a number of tickets, or any combination thereof. The ticket data may include reference information, such as, for example, a date, time, flight number, etc. for the number of flights. The ticket vendor server 106 may include an interface 116 configured to communicate with an interface 122 of the control server 102. The ticket vendor server 106 may provide ticket data to the control server 102 by utilizing interface 116 to communicate the air traffic operation data to interface 122. The ticket vendor server 106 may receive data associated with a congestion premium from the control server 102 via interface 116.

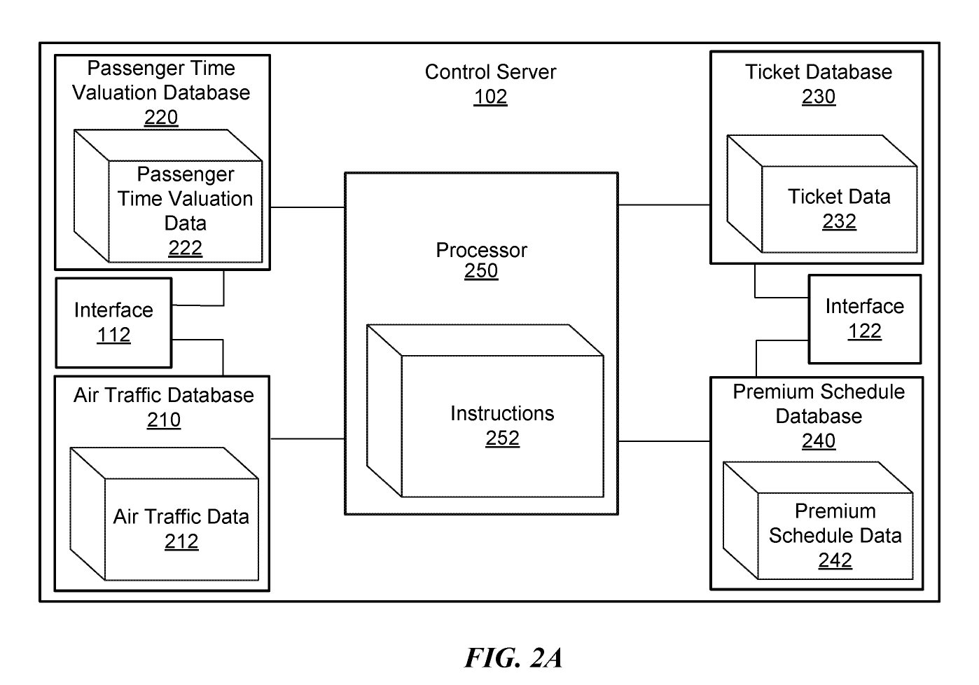

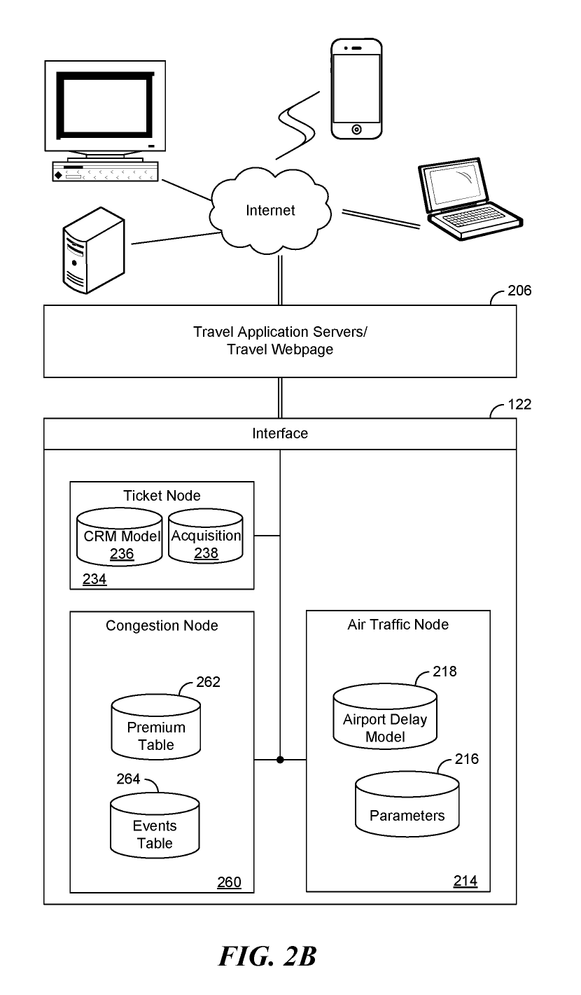

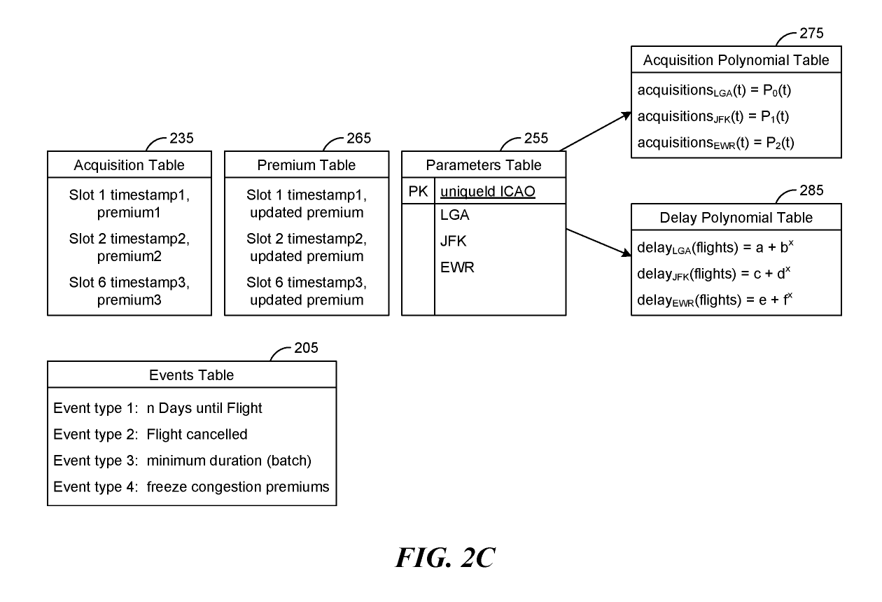

Control server 102 may determine a congestion premium for tickets for a number of flights. Control server 102 may include databases (e.g., including data received from one or more other servers) at least one processor (e.g., a processor to determine a congestion premium), at least one interface to communicate with other server(s). The databases can include, for example, an air traffic database, ticket database, passenger time valuation database, and premium schedule database. The databases may be contained on separate physical memory devices within the control server 102 or can be maintained in separate addresses of physical memory within the control server 102. Control server 102 may communicate with the ATAS server 104 and the ticket vendor server 106. Control server 102 may communicate with ATAS server 104 using, for example, interface 112. Control server 102 may communicate with ticket vendor server 106 using, for example, interface 122. Control server 102 may receive ticket data from ticket vendor server 106 and transmit data associated with a congestion premium for tickets of a number of flights to ticket vendor server 106. Embodiments of various elements within control server 102 are described below with reference to FIG. 2.

FIG. 2A is a block diagram illustrating the control server 102, according to various embodiments. Control server 102 may include at least one processor (e.g., to determine a congestion premium), databases (e.g., to store air traffic data and ticket data), and interfaces (e.g., to communicate with other servers). A processor (e.g., processor 250) may execute a congestion control application to manage the databases (e.g., air traffic database 210, ticket database 230, etc.). The congestion control application may be a computer program designed to perform a group of coordinated functions, including managing databases associated with the control server 102. The congestion control application may be designed to create, query, update, and administer databases (e.g., air traffic database 210) within or connected via an interface (e.g., interface 112, interface 122, etc.) to the control server 102.

The control server 102 may include processor 250. Processor 250 may be, for example, a stand-alone central processing unit (CPU), one of a plurality of specialized processors, or one of a plurality of CPUs. For example, processor 250 may be part of a multi-core processor, where processors of the multi-core processor can carry out instructions at the same time to increase speed via parallel computing. In another example, processor 250 may be one processor of a multi-processor computer. In another example, processor 250 may be part of a computer clustered with a plurality of other computers to carry out computation in parallel. Due to potentially large volumes of air traffic data and ticket data, parallel computing (e.g., multiple processors and/or multiple computers performing operations synchronously) may enable computations to be performed in a reasonable time frame. In addition, determining a congestion premium may be an iterative process requiring feedback from the ticket vendor server 106 to reevaluate a congestion premium. An iterative process requiring computations for potentially many thousands of flights may be performed in parallel by utilizing multiple processors running in parallel to enable computation in near real time. Significant delays in computation may make integration of a congestion premium into a vendor server impractical or impossible. In addition, protracted computation may make performance of iterative reevaluation of a congestion premium impractical or impossible. Thus, embodiments enabling expeditious computations are preferred. The at least one processor (e.g., processor 250) may carry out instructions (e.g., instructions 252) of a congestion control program by performing a series of operations specified by the instructions. The at least one processor (e.g., processor 250) may fetch the instructions from a memory device and execute the instructions by directing coordinated operations between an arithmetic logic unit (ALU), registers, and other components.

The databases of the control server 102 may include, for example, air traffic database 210, passenger time valuation database 220, ticket database 230, and premium schedule database 240. The databases may be, for example, primary storage, secondary storage, or tertiary storage. The databases may include, for example, non-volatile memory, dynamic random-access memory, and/or static random-access memory. The databases may be included in a single memory device or a plurality of memory devices.

Air traffic database 210 may be an organized collection of air traffic data 212 having a data model that reflects the structure of the air traffic data 212. The processor 250 may obtain air traffic data from the ATAS server 104 via interface 112 and populate and/or update the air traffic database 210 with the obtained air traffic data. Populated and/or updated data in air traffic database 210 may be referred to as air traffic data 212.

The air traffic data 212 may include data indicating a number of flights associated with a slot (or plurality of slots) at an airport (or a plurality of airports). The air traffic data 212 may indicate, for example, an actual and/or scheduled takeoff time, an actual and/or scheduled landing time, an actual and/or scheduled departure location, an actual and/or scheduled arrival location, a type of aircraft, passenger capacity, an actual and/or scheduled number of passengers, crew details, or any combination thereof. Air traffic database 210 may have a data model that reflects a flight and details associated with the flight (e.g., scheduled and actual takeoff time of the flight, etc.).

Passenger time valuation database 220 may be an organized collection of passenger time valuation data 222 having a data model that reflects the structure of the passenger time valuation data 222. A passenger time valuation method may be implemented to generate passenger time valuation data 222. In an embodiment, some data may be extracted from the air traffic database 210 (e.g., distance of travel) and some data may be extracted from the ticket database 230 (e.g., ticket type). The congestion control application may extract passenger data from the air traffic data 212 and the ticket database 230 to generate passenger time valuation data 222 in passenger time valuation database 220. For example, data associated with a number of passengers scheduled for a flight may be extracted from the air traffic database 210 and included in a passenger time valuation model based on one or more variables such as, for example, trip purpose (e.g., business or personal travel), identified characteristics of passenger (e.g., age, sex, education, employment, income, etc.), distance of travel, and ticket type (e.g., economy, business, first class, etc.).

Ticket database 230 may be an organized collection of ticket data 232 having a conceptual data model that reflects the structure of the ticket data 232. The processor 250 may obtain ticket data from a remote server (e.g., ticket vendor server 106) via the interface 122 and populate and/or update the ticket database 230. Populated and/or updated data in ticket database 230 may be referred to as ticket data 232.

Ticket data 232 may include data indicating, for example, a number of tickets sold for a flight, number of tickets available for a flight, ticket value, taxes and/or fees associated with a ticket, characteristics of a passenger (e.g., age, sex, education, employment, income, etc.) associated with a ticket, trip purpose (e.g., business or personal travel), and ticket type (e.g., economy, business, first class, etc.). The processor 250 may periodically obtain ticket data from the remote server to update the ticket database 230. For example, the processor 250 may request ticket data from the remote server subsequent to an elapse of a time period (e.g., a minute, several minutes, hour, several hours, day, etc.). Updated ticket data 232 may be used in iterative determinations performed by the processor 250. For example, the processor 250 may reevaluate a congestion premium based on updated ticket data 232.

In an embodiment, additional information may be obtained from the ticket vendor server 106 (e.g., in the event the ticket vendor is an airline). The processor 250 may obtain additional data from a remote server (e.g., ticket vendor server 106) via interface 122 and populate and/or update a database (e.g., ticket database 230) with the additional data. The additional data may include, for example, a number of crew members associated with a flight, crew details (e.g., job title, working hours, experience level, etc.), etc.

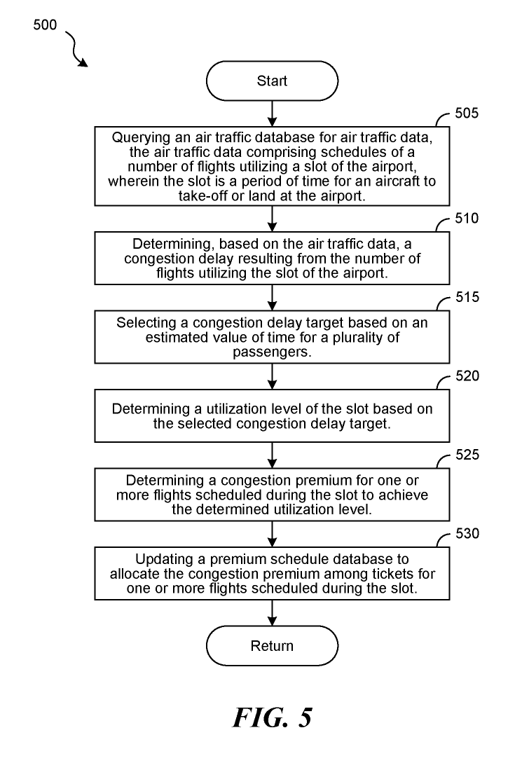

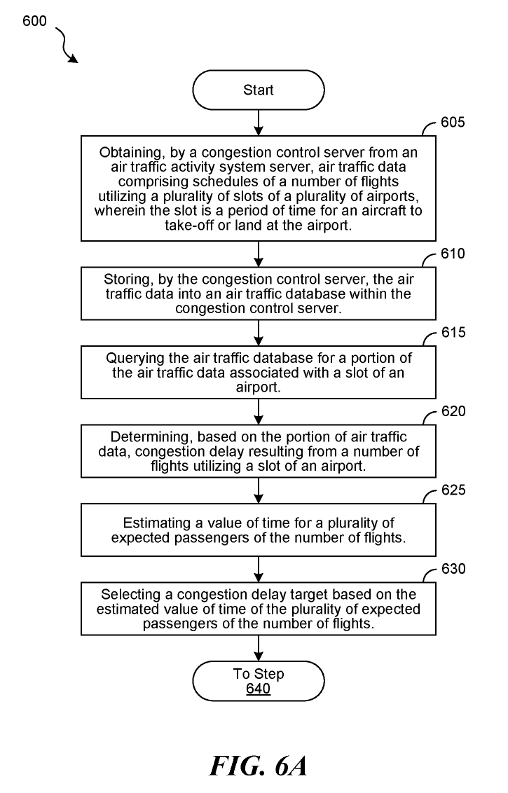

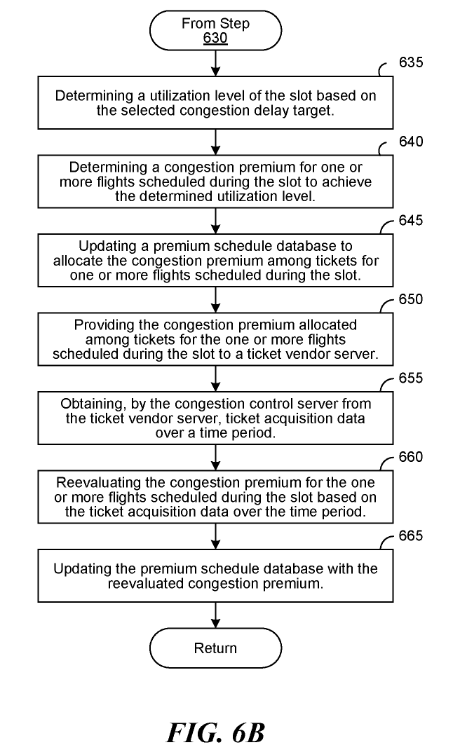

Premium schedule database 240 may be an organized collection of premium schedule data 242 having a data model that reflects the structure of the premium schedule data 242. A premium schedule valuation method may be implemented to generate premium schedule data 242. The premium schedule valuation method may include determining a congestion delay resulting from a number of flights utilizing a slot of an airport, selecting a congestion delay target based on an estimated time value of a plurality of passengers (e.g., extracted from the passenger time valuation database 220), determining a utilization level of the slot based on the selected congestion delay target, and determining a congestion premium for flights scheduled during the slot to achieve the determined utilization level. Various embodiments of the premium schedule valuation method are described below with reference to FIGS. 5-6B. Premium schedule database 240 may be updated to reflect the determined congestion premium. The congestion premium may be allocated among tickets for one or more flights scheduled during the slot. Premium schedule data 242, including a congestion premium allocated among tickets, may be provided to the ticket vendor server 106 via interface 112.

In an embodiment, the congestion premium may be periodically reevaluated based on updated data (e.g., ticket data 232) in one or more databases (e.g., ticket database 230). For example, ticket data 232 may be updated subsequent to providing the premium schedule data 242 to the ticket vendor server 106. Updated ticket data 232 may indicate, for example, a number of tickets sold in a time period (e.g., an hour) after implementation of the congestion premium. Based on the number of tickets sold in the period, the congestion premium may be reevaluated. For example, if a rate of ticket sales is less than needed to achieve the determined utilization level, the congestion premium may be reduced. In another example, if the rate of ticket sales is more than needed to achieve the determined utilization level, the congestion premium may be increased. In an embodiment, a change in a congestion premium may be reflected in a final charge to a passenger (e.g., by refunding the passenger for a subsequently reduced congestion premium).

FIG. 2B is a block diagram illustrating components of the integrated management system, according to various embodiments. The integrated management system can include an interface 112 and/or another interface configured to query travel application servers and/or travel webpage 206. The interface 112 can iteratively retrieve ticket data for analysis by a ticket node 234. The ticket node 234 can determine acquisition information based on changes in the ticket data retrieved from by the interface 122 over various iterations. The ticket node 234 generates an acquisition table 238. The ticket node 234 employs a customer relationship management (CRM) model to predict acquisition over time. Acquisition prediction can be based on characteristics of a number of customers, identified acquisition trends, adjustments to a premium, or any combination thereof.

A congestion node 260 can execute an aviation model to predict congestion for an airport having a particular configuration. An airport can have one or more configurations. For example, La Guardia Airport (LGA) operates in three typical configurations that re-route aircraft operations (e.g., takeoff and landing) to different runways. Different configurations can result in different congestion even with the same number of flight operations in a slot. Predicting an airport's configurations for a slot can greatly increase accuracy of likely congestion from a number of flight operations. Congestion node 260 can include an events table indicative of flight operations, flight duration, flight status, and premium status. Congestion node 260 can include a premium table indicative of a predicted premium to lower congestion to a target congestion.

FIG. 2C is a block diagram illustrating disparate data integrated into a plurality of tables, according to various embodiments. For example, ticket data can be analyzed to determine acquisition data (e.g., an acquisition rate of tickets, total ticket acquisition, and ticket premium). Acquisition data can be sorted and stored in an acquisition table 235. A premium table 265 can include an updated premium and a timestamp corresponding to a time stamp in the acquisition table 235. The air traffic database 210 can be iteratively queried to identify events and event changes. Identified events and event changes can be sorted and stored in an events table 205.

A parameters table can include a profile for each airport. The airport profile can be indicative of one or more airport configurations. The airport profile can include cross-reference information corresponding to configurations of other airports. Configurations indicate aircraft operation locations at an airport (e.g., where aircraft takeoff and land). Some airports can reconfigure to several operations (e.g., LGA can operate in three different configurations). In an example, a first configuration of LGA can be cross-referenced with a second configuration at JFK but not with any configuration at LAX. The cross-reference information can include a probability of alteration of a configuration at a particular airport upon a change of a configuration at another airport. The cross-reference information can be used to predict a particular configuration for an airport at a particular slot. The particular configuration during the slot can be used to generate a delay function (e.g., a delay polynomial). If a particular configuration is less than a threshold level of certainty, a delay function can be generated for a plurality of configurations. A weighting (e.g., a value between 0 and 1) corresponding to the probability of each configuration can be associated with each delay function. The weighting can be used to generate a weighted average delay function indicative of a delay from possible configurations.

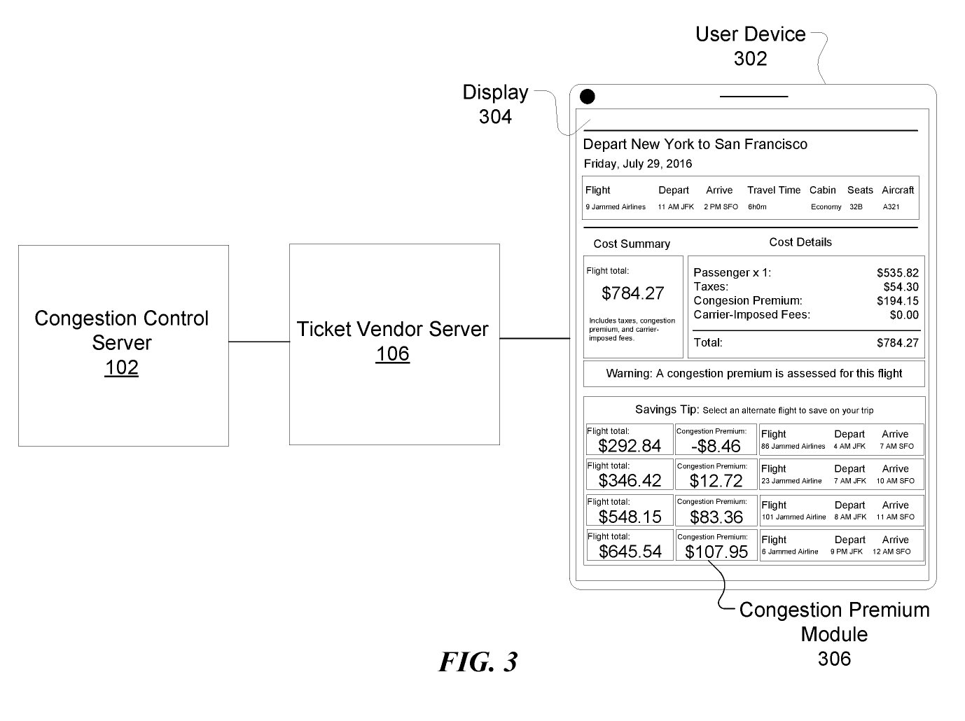

FIG. 3 is a graphical illustration of the control server 102 providing congestion premium data to a user device 302, according to various embodiments. In an embodiment, control server 102 may provide congestion premium data to the ticket vendor server 106, and the ticket vendor server 106 may provide congestion premium data to the user device 302. Although not illustrated, embodiments also include control server 102 providing congestion premium data directly to the user device 302.

A user can interface with a browser and/or mobile application executed by a user device (e.g., user device 302) configured to connect to a flight search engine. The browser and/or mobile application can receive flight selections from the user. The browser and/or mobile application can generate a query and transmit the generated query to the flight search engine (315).

The flight search engine can receive the query generated by the browser and/or mobile application. The flight search engine can execute a search query. The search query can be performed by mining data available in databases or open directories (e.g., one or more generated tables). The flight search engine can maintain real-time information by running an algorithm on one or more ticket vendor servers and one or more air traffic servers.

The user device 302 may include a graphical user interface configured to generate one or more graphical elements (e.g., congestion premium module 306) to display on a display 304. The graphical user interface may generate the congestion premium module 306 including a congestion premium associated with a flight. For example, the congestion premium module 306 may indicate a congestion premium of $107.95 associated with flight “6 Jammed Airlines” which departs John F. Kennedy International Airport (“JFK”) at 9 PM Eastern Time and arrives at San Francisco International Airport (“SFO”) at 12 AM Pacific Time. In another example, a congestion premium module may indicate a congestion premium of −$8.46 associated with flight “86 Jammed Airlines” which departs JFK at 4 AM Eastern Time and arrives at SFO at 7 AM Pacific Time. A congestion premium determined for various slots throughout a day may vary based on a reduction of a number of flights necessary to achieve a utilization level for the various slots.

A user of the user device 302 may select a ticket for a flight having a congestion premium allocated to the ticket. The allocated congestion premium may be based on a congestion premium determined by the control server 102. For example, if the control server 102 determines that a congestion premium of $194,150 may achieve the determined utilization level (e.g., 75% of maximum runway capacity) for a slot (e.g., 11:00 AM-11:30 AM) and 1,000 tickets are available for flights during the slot, the control server 102 may allocate the congestion premium among available tickets. The control server 102 may allocate the congestion premium evenly among tickets or based on one or more other factors (e.g., ticket type, ticket price, aircraft type of flight, leg room available, etc.). For example, a congestion premium may be allocated evenly by dividing a congestion premium (e.g., $194,150) by a number of tickets available during a slot (e.g., 1,000 tickets) to obtain an allocated congestion premium (e.g., a congestion premium $194.15 per available ticket). In another example, a congestion premium may be allocated by aircraft type so that tickets associated with an aircraft occupying a larger duration of takeoff time are allocated a proportionally larger portion of the congestion premium.

A positive congestion premium may result in fewer flights in a slot, whereas a negative congestion premium may result in more flights in a slot. For example, the congestion premium of $107.95 allocated to tickets for flights in a slot (e.g., 9 PM-9:30 PM) may disincentivize flights operating during the slot. In another example, the congestion premium of −$8.46 allocated to tickets for flights in a slot (e.g., 4:00 AM-4:30 AM) may incentivize additional flights to operate during the slot.

Referring to FIGS. 1-3, physical and functional components (e.g., devices, engines, modules, and databases, etc.) associated with the congestion server 102, the ATAS server 104, the ticket vendor server 106, and/or the user device 302 can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer readable data storage. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the components may operate individually and independently of other components. Some or all of the functional components may be executed on the same host device or on separate devices. The separate devices can be coupled through one or more communication channels (e.g., wireless or wired channel) to coordinate their operations. Some or all of the components may be combined as one component. A single component may be divided into sub-components, each sub-component performing separate method step or method steps of the single component.

In some embodiments, at least some of the components share access to a memory space. For example, one component may access data accessed by or transformed by another component. The components may be considered “coupled” to one another if they share a physical connection or a virtual connection, directly or indirectly, allowing data accessed or modified by one component to be accessed in another component. In some embodiments, at least some of the components can be upgraded or modified remotely (e.g., by reconfiguring executable instructions that implements a portion of the components). Other arrays, systems and devices described above may include additional, fewer, or different components for various applications.

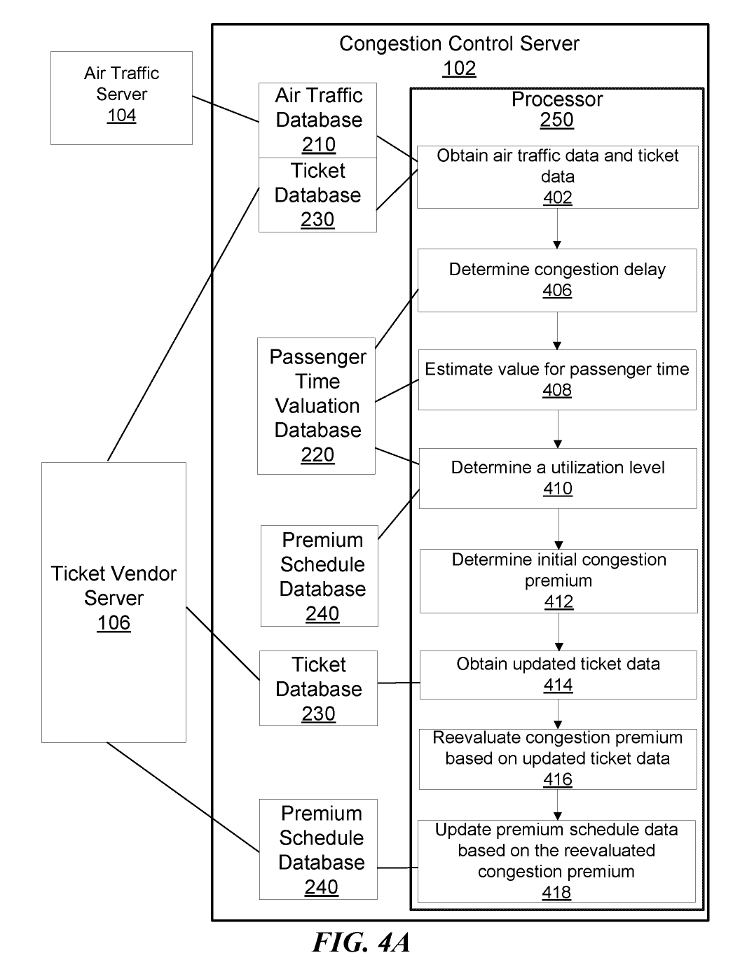

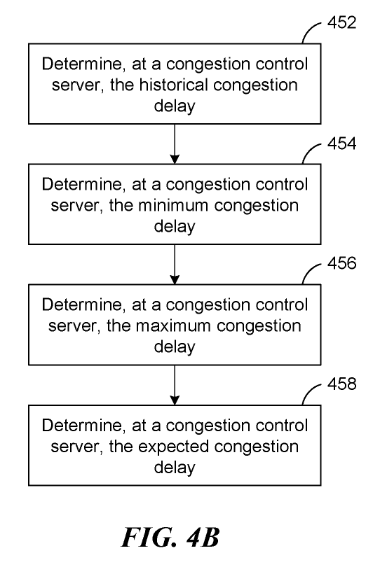

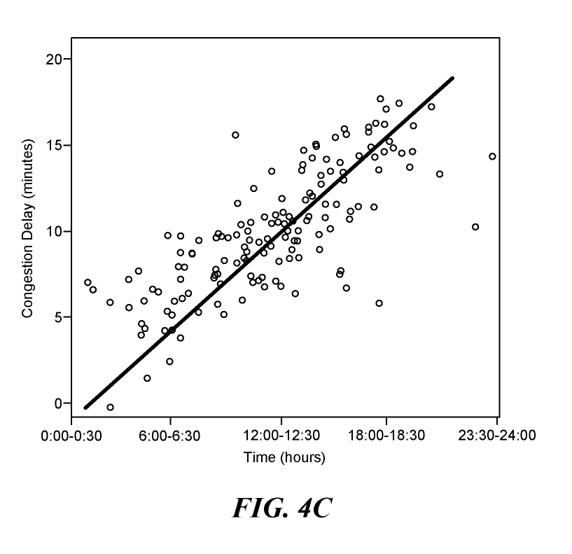

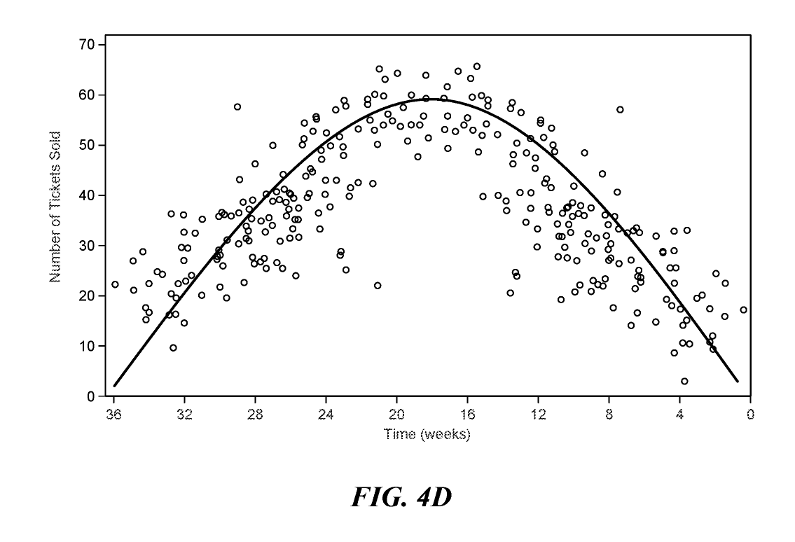

FIG. 4 is a graphical illustration of a control server 102 performing a method, according to various embodiments. Embodiments include one or more processors (e.g., processor 250) of the control server 102 executing a congestion control application to utilize air traffic data 212 to determine a congestion premium. More specifically, the congestion control application may obtain air traffic data and ticket data (step 402) from the air traffic database 210 and the ticket database 230, determine expected delays for passengers travelling during a slot (step 406), estimate value for passenger time (step 408), determine a utilization level of a runway at an airport (step 410), determine an initial congestion premium to achieve the determined utilization level (step 412), obtain updated ticket data from the ticket database 230 (step 414), reevaluate the congestion premium based on updated ticket data (step 416), and update premium schedule data in the premium schedule database 240 based on the reevaluated congestion premium (step 418). Arrows may be shown to denote a chronological flow of the method. However, the arrows are included merely to show examples of a possible method flow and should not be construed as a limitation of possible method flows. Embodiments include steps of the method being performed in various orders that may differ from those depicted in FIG. 4. A person skilled in the art would appreciate the various embodiments disclosed herein.

In step 402, the congestion control application may obtain air traffic data and ticket data from the air traffic database 210 and the ticket database 230. The congestion control application may transmit a message to the ATAS server 104 including a query for air traffic data (e.g., via a communication interface). In response for the query for air traffic data, the ATAS server 104 may transmit a message to the control server 102 including the air traffic data. The control server 102 may receive the air traffic data transmitted by the ATAS server 104. The processor 250 may identify the data received from the ATAS server 104 as air traffic data by evaluating the message transmitted from the ATAS server to determine, for example, a host identification (host ID) associated with the message, a data structure of the message, a tuple and/or list associated with air traffic data, or any combination thereof. For example, the processor 250 may identify a first tuple (e.g., a sequence of immutable Python objects) associated with a plurality of airports and a second tuple associated with a plurality of flights. Based on the identification of the first tuple and the second tuple, the processor 250 may determine that the received data is air traffic data. In response to determining the received data is air traffic data, the processor 250 may store the received data in the air traffic database 210. Air traffic data stored in the air traffic database 210 may be utilized in one or more subsequent steps.

The congestion control application may transmit a message to the ticket vendor server 106 including a query for ticket data (e.g., via a communication interface). In response for the query for ticket data, the ticket vendor server 106 may transmit a message to the control server 102 including the ticket data. The control server 102 may receive the ticket data transmitted by the ticket vendor server 106. The processor 250 may identify the data received from the ticket vendor server 106 as ticket data by evaluating the message transmitted from the ticket vendor server 106 to determine any of a host ID associated with the message, a data structure of the message, a tuple and/or list associated with air traffic data, or any combination thereof. For example, the processor 250 may identify a first tuple (e.g., a sequence of immutable Python objects) associated with a plurality of available tickets and a second tuple associated with a plurality of ticket prices. Based on the identification of the first tuple and the second tuple, the processor 250 may determine that the received data is ticket data. In response to determining the received data is ticket data, the processor 250 may store the received data in the ticket database 230. Ticket data stored in the ticket database 230 may be utilized in one or more subsequent steps.

In step 406, the congestion control application may determine a congestion delay. The congestion delay may be determined based on the number of flights utilizing a slot of an airport. For example, if five flights are scheduled to utilize a runway at an airport during between 11:00 AM and 11:30 AM, and a seven minute gap is required between a takeoff of each flight, a five-minute congestion delay may result.

In an embodiment, a congestion delay determined for a slot may account for delays determined from previous slots. For example, if one or more prior slots (e.g., 10:30 AM-11:00 AM slot, 10:00 AM-10:30 AM slot, etc.) are determined to have a congestion delay, the congestion delay of the prior slot may be added to the congestion delay of a subsequent slot. If a number of flights scheduled during the 10:30 AM-11:00 AM slot are determined to result in a six-minute delay and the 11:00 AM-11:30 slot is determined to result in a five-minute delay, the congestion delay for the 11:00 AM-11:30 AM slot may be determined to be eleven minutes. Thus, the congestion delay for a slot may be a cumulative delay resulting from a number of flights in the slot and flights from previous slots that may affect the slot.

In an embodiment, a congestion delay determined for a slot may not include delays from a previous slot if an intervening slot is determined to compensate for the delay. For example, if a first number of flights in a first slot (e.g., 8:00 AM-8:30 AM) is determined to result in a 10-minute delay, a second number of flights in a second slot (e.g., 8:30 AM-9:00 AM) is determined to result in a 10-minute surplus of time, and a third number of flights in a third slot (e.g., 9:00 AM-9:30 AM) is determined to result in a 5-minute delay, the congestion delay for the third slot may be determined to be 5 minutes since the second slot may cancel out the delay from the first slot.

In an embodiment, a congestion delay determined for a slot may account for a residual delay from one or more previous slots. A residual delay may be an estimated remaining delay after a prior slot. For example, if a first number of flights in a first slot (e.g., 8:00 AM-8:30 AM) is determined to result in a 14 minute delay, a second number of flights in a second slot (e.g., 8:30 AM-9:00 AM) is determined to result in a 10-minute surplus of time, and a third number of flights in a third slot (e.g., 9:00 AM-9:30 AM) is determined to result in a 5-minute delay, the congestion delay for the third slot may be determined to be 9 minutes since the second slot may reduce a residual delay from the first slot.

In step 408, the congestion control application may estimate a value for passenger time. Data for estimating the value for passenger time may be extracted from, for example, the air traffic database 210 (e.g., data indicating a distance of travel) and the ticket database 230 (e.g., data indicating a ticket type). Data associated with the value for passenger time may be stored in the passenger time valuation database 220.

Estimating a value for passenger time may be based on one or more variables such as, for example, trip purpose (e.g., business or personal travel), identified characteristics of passenger (e.g., age, sex, education, employment, income, etc.), distance of travel, and ticket type (e.g., economy, business, first class, etc.). Various embodiments for estimating a value for passenger time are discussed below. Some embodiments may determine different values for different passengers. Some embodiments may estimate a same value for one or more passengers based on one or more common variables shared between the passengers.

In an embodiment, the value of time for a passenger may be estimated to be the same as the value of travel time savings (VTTS) determined by the United States Department of Transportation (USDOT). Data associated with the VTTS may be obtained from a USDOT server via the control server 102. VTTS may vary depending on one or more other variables. For example, VTTS for a trip purpose defined as “business” may be $60.00 per hour. In another example, VTTS for a trip purpose defined as “personal” may be $32.60 per hour. Embodiments include assuming an annual rate of growth of 1.2 percent of real median household income to determine an increase in VTTS in any given year.

In an embodiment, a value of time for a passenger may be estimated by dividing an annual income of the passenger divided by 2,080 hours per year to obtain an hourly value of time for the passenger. Annual income of a passenger may be extracted from the ticket database 230 (e.g., $100,000 per year). The extracted annual income of $100,000 per year may be divided by 2,080 hours to obtain an estimated hourly value of time for the passenger of $48.08. In an embodiment, if income data is not available for a passenger, a default annual income value may be used. The default annual income value may be the median annual of airline travelers. For example, the median annual income of airline travelers in a given year (e.g., $70,000) may be divided by 2,080 hours to obtain an estimated hourly value of time for the passenger of $33.65. If data of a current year median annual income is not available, data associated with a prior year median annual income may be used and an annual rate of growth of 1.2 percent for median annual income may be assumed.

In step 410, the congestion control application may determine a utilization level of a runway at an airport. The utilization level of the runway at the airport may be a percentage of a maximum capacity of the runway at the airport. For instance, under ideal conditions (e.g., perfect weather, no human error, etc.) an airport may be determined to have a maximum throughput of 45 scheduled operations per slot (e.g., 45 scheduled operations per half hour).

The utilization level (e.g., 87% of maximum capacity) may be determined based on a determined congestion delay target (e.g., 6-minute delay). The airport may have 40 operations (e.g., flight takeoffs and/or landings) actually scheduled for the slot. A congestion delay (based on, for example, historical air traffic data) of 10 minutes may be determined for the 40 operations during the slot. A congestion delay target of 6 minutes may be selected for the slot based on, for example, a determined convergence between a cost of reducing the congestion delay and a value of time of passengers. For example, a value of time of 5000 passengers scheduled for the 40 operations may amount to $190,400 per hour (e.g., if 1000 business passenger have a time value of $60 per hour and 4000 personal passengers have a time value of $32.60 per hour) or $12,693 for 4 minutes. Reducing the congestion delay by 4 minutes (e.g., from 10 minutes to 6 minutes) may require reducing the 40 operations to 39 operations by discontinuing operation of a single small aircraft during the slot, which may cost $12,700. Since the cost of discontinuing operation of the small aircraft achieves a 4-minute congestion delay reduction which is approximately equal to the estimated value of 4 minutes for the passengers during the slot, a congestion delay reduction of 4 minutes may be selected. A convergence between the cost of reducing the congestion delay and the value of time of passengers may be determined by identifying a closest match between the cost of reducing the congestion delay and the value of time of passengers.

If a maximum capacity of a slot at an airport is 45 scheduled operations and reducing operations to 39 may achieve a determined congestion delay target, a utilization level of 87% (i.e., 39 operations divided by maximum capacity of 45 operations) may be determined.

In step 412, the congestion control application may determine an initial congestion premium to achieve the determined utilization level. Achieving the determined utilization level may involve, for example, disincentivizing flights during peak slots and/or incentivizing flights during non-peak slots. Achieving the determined utilization level may involve, for example, a decrease in ticket selection for flights during a peak slot and/or an increase in ticket selection for flights during a non-peak slot. In an embodiment, the congestion control application may determine a cost of reducing the congestion delay (e.g., the cost of discontinuing operation of one or more flights). The cost of reducing the congestion delay may be allocated among tickets for flights during a slot.

In another embodiment, the congestion control application may evaluate ticket purchase patterns identified in ticket data to determine an initial congestion premium. For example, if a 5% decrease in ticket selection is needed to achieve the determined utilization level, a value corresponding to a decrease in ticket selection by 5% may be identified in the ticket data based on historical reductions in ticket selection. If a value of $50 is determined to decrease ticket selection by 5%, the congestion control application may determine that an initial congestion premium of $50 may achieve the determined utilization level.

The initial congestion premium may be stored in the ticket database 230. The initial congestion premium may be allocated among tickets for one or more flights scheduled during the slot. The congestion premium may be provided to the ticket vendor server 106. The congestion premium may be provided to a user device (e.g., user device 302).

In step 414, the congestion control application may obtain updated ticket data from, for example, the ticket vendor server 106. The updated ticket data may be obtained subsequent to providing the congestion premium to the ticket vendor server 106. The updated ticket data may include data associated with one or more selections of a ticket including the congestion premium.

In an embodiment, the congestion control application may receive ticket data from the ticket vendor server 106. The ticket vendor server 106 may transmit ticket data representing available tickets at a given time for a specific flight. For example, the ticket data may illustrate that historically, 30 tickets are available on June 1 for a flight departing July 1 of the same year. The ticket data may represent a historical overview of available tickets for a flight at a specific time for previous flights. For example, the ticket data can represent data showing that on June 1 from 2001-2011 an average of 35 tickets are available on June 1 for a flight departing July 1 of the same year.

The congestion control application may generate an expected ticket acquisition function based on the ticket data received from the ticket vendor server 106. The expected ticket acquisition function may be a polynomial generated by the congestion control application based on historical ticket acquisition data over time prior to the departure for a specific flight. The polynomial may be a first order or second order polynomial utilizing curve fitting to generate a polynomial based on the historical ticket acquisition information received by the ticket vendor server 106.

The congestion control application may estimate the number of available seats at a specific time prior to the time slot of a flight based on the expected ticket acquisition function. The congestion control application may evaluate the expected ticket acquisition function based on the amount of time remaining before the scheduled time slot of a specific flight. The expected ticket acquisition function may determine the estimated available seats remaining for a specific flight based on historical ticketing data.

In some embodiments, the congestion control application may determine whether the congestion premium has disincentivized air passengers from purchasing peak time slot flights based on the ticket acquisition data received from the ticket vendor application. The congestion control application may compare the actual ticket acquisition information with the estimated available seats remaining based on the expected ticket acquisition function. For example, the estimated available seats remaining at a specific time may estimate that 40 seats should be available, but the actual ticket acquisition data shows that 10 seats are available. In this example, the congestion premium may be too low, as air passengers were continued to purchase peak time slot flights with a congestion premium.

In another example, the estimated available seats remaining at a specific time may estimate that 40 seats should be available, but the actual ticket acquisition data shows that 50 seats are available. In this example, the congestion premium may be appropriate or too high of a value, as the congestion premium has discouraged air passengers from purchasing the peak tickets at a rate greater than the historical average. Comparing the available seats for a flight with a historical expected ticket acquisition function may demonstrate whether the congestion premium value is appropriate or inappropriate. This comparison may be utilized in reevaluating and updating the congestion premium (e.g., step 416).

In step 416, the congestion control application may reevaluate the congestion premium based on updated ticket data. The congestion control application may determine, based on the updated ticket data, a selection rate of tickets including the congestion premium. The selection rate may be used to reevaluate the congestion premium. A determined selection rate lower than an expected selection rate may result in decreasing the congestion premium. For example, if an expected selection rate is 12 tickets per business day and a determined selection rate is 2 tickets per business day, the congestion premium for the tickets may be decreased. A determined selection rate higher than expected may result in increasing the congestion premium. For example, if an expected selection rate is 12 tickets per business day and a determined selection rate is 20 tickets per business day, the congestion premium may be increased.

The congestion premium may be reevaluated by the congestion control application based on multiple sources of data received from multiple applications. The congestion control application may receive ticket acquisition data from the ticket vendor application. The congestion control application may generate an expected ticket acquisition function based on the historical ticket acquisition data. The congestion control application may dynamically receive updated actual ticket acquisition data from the ticket vendor application. The congestion control application may evaluate the expected ticket acquisition function for a specific time prior to the scheduled time slot of the flight. The congestion control application may compare the evaluated expected ticket acquisition function with the actual ticket acquisition data to determine a difference between expected available seats and actual available seats for a specific time prior to the time slot of a flight.

The congestion control application may utilize the difference between expected available seats and the actual available seats to reevaluate the congestion premium. The congestion premium may be changed depending on whether the actual available seats information exceeds or falls below the expected available seats derived from the expected ticket acquisition function.

For a first example, the expected available seats evaluated from the expected ticket acquisition function four weeks before the scheduled peak time slot of a flight may return 50 expected available seats. If the actual ticket acquisition data indicates that only 25 seats are left for the flight four weeks before the scheduled time slot, 25 more seats were bought by air passengers paying the congestion premium. This may indicate that the congestion premium should be increased to discourage ticket sales for the peak time slot flight.

To determine how much to change the congestion premium, multiple processes may be performed. In some embodiments, the expected available seats may be divided by the actual number of available seats. In the first example, if the congestion premium is $100, for example, and the expected available seats are 50, and the actual available seats are 25 seats. The ratio of expected available seats to actual available seats is 2. In the first example, the congestion premium of $100 may be multiplied by the ratio of expected/actual available seats, which may determine an updated congestion premium of $200.

In an embodiment, the congestion premium may be reevaluated by taking the difference between the expected available seats and the actual available seats, and multiplying the difference by the congestion premium. The congestion control application may evaluate the estimated ticket acquisition function at various points in time. For example, the congestion control application may evaluate the estimated ticket acquisition function at the scheduled time slot of the flight, i.e. the last time to purchase a ticket. The congestion control function may determine the difference between the estimated ticket acquisition function at the scheduled time slot of the flight and the estimated ticket acquisition function at a given point in time prior to the scheduled time slot of the flight.

In an embodiment, the updated congestion premium may be bounded by a minimum congestion premium and a maximum congestion premium. The updated congestion premium may not exceed the maximum congestion premium. The updated congestion premium may not fall below the minimum congestion premium.

In step 418, the congestion control application may update premium schedule data in the premium schedule database 240 based on the reevaluated congestion premium. The reevaluated congestion premium may be stored in the premium schedule database 240. The reevaluated congestion premium may be provided to the ticket vendor server 106 and allocated to tickets of one or more flights scheduled during the slot.

Steps 414, 416, and 418 may be performed iteratively until the determined selection rate is within a threshold of the expected selection rate. The threshold may be, for example, less than two standard deviations, less than one standard deviation, less than one-half of one standard deviation, less than one-quarter of one standard deviation, or any other proportion of one standard deviation.

FIG. 4B illustrates an example method 450 of determining an expected congestion delay. The method as illustrated in FIG. 4B may be utilized to determine a congestion delay. The control server 102 may determine the expected congestion delay.

In step 452, a historical congestion delay may be determined. The historical congestion delay may be determined using a control server (e.g. 102). The control server 102 may utilize airport data including, for example, airplane takeoff/landing times, historical airport delays, plane model and size, and passengers per plane. The airport data may be provided by an air traffic activity system (ATAS) server. The control server 102 may dynamically receive historical data by the ATAS server to update historical data for each airport. The control server 102 may distinguish historical data for a specific date. The control server may distinguish each a time slot for each flight during the specific date, and determine the congestion delay of each flight on a specific date.

The control server 102 may utilize mathematical functions to determine historical congestion delays. Finding historical congestion delay functions can be advantageous to utilize historical flight information to reasonably predict future congestion delays of a flight for a specific time slot and date.

The control server 102 may determine a historical congestion delay function at each airport as a function of time. For example, the control server 102 may determine the historical congestion delay function at John F. Kennedy International airport (JFK) for the date of Jul. 1, 2011. To determine the historical congestion delay function, the control server 102 may receive many years' worth of airport and flight information from the ATAS server. For example, the control server 102 may generate a historical congestion delay function based on airport data for JFK airport from 2001-2011 to determine an estimated congestion delay for Jul. 1, 2011.

The control server 102 may determine each data point using historical airport information from the ATAS server. For example, each data point may represent congestion delay during a specific time slot on a specific prior date. The control server 102 may determine congestion delay for each time slot on a specific date using the prior airport information from the ATAS server. For example, the control server 102 may determine congestion delay for a specific date by analyzing differences between expected departure times and actual departure times for each flight within a time slot.

The historical congestion delay function may be represented in the form of a polynomial. The polynomial may be in the first order, or the polynomial may be determined at a higher order based on computational resources. If the polynomial is of a higher order, the polynomial may exhibit greater accuracy, but the high-order polynomial may require greater computational resources to determine expected congestion delay. The historical congestion delay function may be determined by utilizing curve fitting on the data points. Curve fitting may include generating a polynomial based on generating a curve, or a mathematical function, based on a best fit to the series of data points as a function of time.

The historical congestion delay function may be determined by utilizing regression analysis, a statistical model for estimating the relationship between the data points. One such technique may include least squares type regression analysis. FIG. 4C is a graph of a polynomial function describing a relationship between congestion delay and a time of day. Congestion delay can increase over the course of a day as previous delays compound subsequent delays.

The historical congestion delay function may be numerically derived at the control server 102. The historical congestion delay function may represent a function of historical congestion delay as a function of time. The historical congestion delay function may be represented as a numerical polynomial. A historical congestion delay function may be generated for each airport for a given date. The control server 102 may utilize the airport-specific historical congestion delay functions for each airport to determine the estimated congestion delay based on flights departing and arriving at each airport.

In step 454, the control server 102 may determine a minimum congestion delay. The minimum congestion delay may be the minimum possible delay for a specific time slot at a specific airport. The control server 102 may utilize the historical congestion delay function found in step 452.

The minimum congestion delay may be determined recursively. For example, the control server 102 may begin with a first flight in a time slot. The control server 102 determine the unimpeded taxi time for a flight, which may include the duration of time for a flight to leave the gate and takeoff without any delay. The control server 102 may determine the minimum congestion delay for the first flight based on an analysis of the historical congestion delay function as a function of time. The control server 102 may determine the taxi duration of the first flight based on the unimpeded taxi time in addition to the historical congestion delay incurred at the given time from the polynomial generated for the historical congestion delay function. For example, if the first flight has an unimpeded taxi time of 6 minutes, and the historical congestion delay function determines that, at the specific time slot, the congestion delay is historically 2 minutes, it may take 8 minutes for the first flight to take off.

The control server 102 may recursively add flights for a given time slot and determining their taxi duration based on the historical congestion delay function and known unimpeded taxi delay times. The control server 102 may keep recursively adding flights until the estimated delay for a given time slot is above the unimpeded taxi time for flights at the specific airport. The control server 102 may recursively add flights based on number of passengers and known taxi durations. For example, the control server 102 may add flights with the greatest amount of passengers as to increase the number of passengers that may takeoff in the time slot without a congestion delay. Different combinations of flights may be added to generate the maximum number of flights that may take off with unimpeded taxi time to generate the minimum congestion delay. The minimum congestion delay may be given a default value, such as 15 minutes, for example.

In step 456, the control server 102 may determine the maximum congestion delay for a time slot. The control server 102 may receive a maximum amount of operations allowed for a given time slot. The maximum amount of operations may be dictated by regulation by an airport regulation body, or a government agency, for example. The control server 102 may determine a maximum congestion by evaluating the historical congestion delay function using the maximum allowed number of operations for a given time slot. This evaluation will determine the maximum allotted congestion delay given the historical congestion delay function determined in step 452.

The maximum congestion delay for a time slot may be determined using data from multiple sources. The control server 102 may be in electrical communication with a server containing data relating to on-time arrival performance and causes for cancellations for each airport. For example, the United States Department of Transportation (U.S. DOT) Bureau of Transportation Statistics (BTS) may comprise a database of average on-time operations, cancelled operations, and reasons for each operation to be cancelled, such as weather, air carrier delay, or aircraft arriving late, for example. The control server 102 may receive the operation cancellation database from a source such as the U.S. DOT BTS, or another similar source.

The control server 102 may receive operation taxi data from a remote server. The server may comprise a known database of average flight taxi times for arriving and departing flights in each time slot. A governmental agency may store a database of average taxi times, such as the U.S. Federal Aviation Administration (FAA) Aviation System Performance Metrics (ASPM) database.

The control server 102 may be in electrical communication with a U.S. DOT BTS server and a U.S. FAA ASPM server. The control server 102 may utilize the operation cancellation statistics and the average taxi times to determine a maximum congestion delay. The maximum congestion delay may be determined by finding the maximum number of allotted flights for a time slot at a given airport. The control server 102 may multiply the maximum number of allotted flights by the average cancellation rate for a given time slot at the given airport to find a maximum cancellation allotment. The control server 102 may multiply the maximum cancellation allotment with the average taxi times for each flight in a time slot at an airport to find a maximum congestion delay for a time slot at an airport.

In step 458, the control server 102 may determine the expected congestion delay. The expected congestion delay may be the congestion delay. The expected congestion delay may comprise the expected delay for each flight in a time slot based on historical data and flight data received by the control server 102. The expected congestion delay generally may comprise a value greater than the minimum congestion delay and a value less than the maximum congestion delay. The expected congestion delay may be desirable to be a value close to the minimum congestion delay, as this will allow for minimal expected delays.

The control server 102 may utilize the historical congestion delay function determined in step 452. The control server 102 may receive data representing the number of flights reserved for a given time slot. The data representing the number of flights may be transmitted by a ticket vendor server 106, the ATAS server 104, or another scheduling database. The control server 102 may receive data representing the amount of flights planning to offer passenger tickets for each flight in a time slot, the average price of the ticket, and the amount of tickets available.

The expected congestion delay may be determined by evaluating the number of flights reserved for a given time slot by the historical congestion delay function. The historical congestion delay function may be a polynomial that may provide an estimated congestion delay in minutes based on the time slot and the number of operations planning to use the time slot. Evaluating the historical congestion delay function and the number of flights reserved for a given time slot may allow for an estimated congestion delay based on the time slot given and historical data representing previous flight times and delays.

FIG. 5 is a flow diagram illustrating a sample process for managing air traffic congestion, according to various embodiments. The sample process of FIG. 5 may involve selecting a congestion premium, based on air traffic data, designed to reduce a congestion delay for a slot of an airport. The sample process may include querying an air traffic database for air traffic data of an airport (step 510), determining a congestion delay resulting from the number of flights utilizing the slot of the airport (step 520), selecting a congestion delay target based on an estimated time value of a plurality of customers (step 530), determining a utilization level of the slot based on the selected congestion delay target (step 540), determining a congestion premium for one or more flights scheduled during the slot to achieve the defined utilization level (step 550), and updating a premium schedule database to allocate the congestion premium among tickets for one or more flights scheduled during the slot (step 560).

In step 510, the congestion control application may query an air traffic database for air traffic data of an airport. The air traffic data may include schedules of a number of flights utilizing a slot of the airport. The slot may be a period of time for an aircraft to take-off or land at the airport.

Querying the air traffic database may include identifying data in the air traffic database associated with a number of flights utilizing a slot of an airport and extracting the data associated with the number of flights utilizing a slot of the airport. The extracted data may be used in one or more subsequent steps.

The air traffic database may be populated with data received from one or more remote servers (e.g., a server associated with the United States Department of Transportation). The air traffic database may be part of a control server, such as, for example, the control server 102 discussed in FIG. 2.

In step 520, the congestion control application may determine, based on the air traffic data, a congestion delay resulting from the number of flights utilizing the slot of the airport. The congestion delay may be determined based on the number of flights utilizing a slot of an airport. For example, a number of flights (e.g., 5 flights) may be scheduled to utilize a runway at an airport during a slot (e.g., between 11:00 AM and 11:30 AM). Various time gaps may be required between a takeoff of each flight based on a wake created by each aircraft (e.g., large aircraft may create a large wake and require a larger time gap). If a time gap required for the flights scheduled during a slot exceeds a time duration of the slot, a congestion delay may result. A residual delay from one or more previous slots may also result in a congestion delay for a slot. Various embodiments for determining a congestion delay based on one or more flights utilizing a slot and a residual delay from prior slots are contemplated.

In an embodiment, a congestion delay determined for a slot may account for delays determined from previous slots. For example, if one or more prior slots (e.g., 10:30 AM-11:00 AM slot, 10:00 AM-10:30 AM slot, etc.) is determined to have a congestion delay, the congestion delay of the prior slot may be added to the congestion delay of a subsequent slot. If a number of flights scheduled during the 10:30 AM-11:00 AM slot is determined result in a six-minute delay and the 11:00 AM-11:30 slot is determined to result in a five-minute delay, the congestion delay for the 11:00 AM-11:30 AM slot may be determined to be eleven minutes. Thus, the congestion delay for a slot may be a cumulative delay resulting from a number of flights in the slot and flights from previous slots that may affect the slot.

In an embodiment, a congestion delay determined for a slot may not include delays from a previous slot if an intervening slot is determined to compensate for the delay. For example, if a first number of flights in a first slot (e.g., 8:00 AM-8:30 AM) is determined to result in a 10-minute delay, a second number of flights in a second slot (e.g., 8:30 AM-9:00 AM) is determined to result in a 10-minute surplus of time, and a third number of flights in a third slot (e.g., 9:00 AM-9:30 AM) is determined to result in a 5 minute delay, the congestion delay for the third slot may be determined to be 5 minutes since the second slot may cancel out the delay from the first slot.

In an embodiment, a congestion delay determined for a slot may account for a residual delay from one or more previous slots. A residual delay may be an estimated remaining delay after a prior slot. For example, if a first number of flights in a first slot (e.g., 8:00 AM-8:30 AM) is determined to result in a 14 minute delay, a second number of flights in a second slot (e.g., 8:30 AM-9:00 AM) is determined to result in a 10-minute surplus of time, and a third number of flights in a third slot (e.g., 9:00 AM-9:30 AM) is determined to result in a 5 minute delay, the congestion delay for the third slot may be determined to be 9 minutes since the second slot may reduce a residual delay from the first slot.

In step 530, the congestion control application may select a congestion delay target based on an estimated value of time for a plurality of passengers. A congestion delay target may be selected for a slot based on, for example, a determined convergence between a cost of reducing the congestion delay and an estimated value of time for passengers. The congestion delay target may be equal to the minimum congestion delay, as determined in FIG. 4B, for example.

Estimating a value of time for passengers may be based on one or more variables such as, for example, trip purpose (e.g., business or personal travel), identified characteristics of passenger (e.g., age, sex, education, employment, income, etc.), distance of travel, and ticket type (e.g., economy, business, first class, etc.). In an embodiment, the value of time for a passenger may be estimated to be the same as the value of travel time savings (VTTS) determined by the United States Department of Transportation (USDOT). In another embodiment, the estimated value of time for passengers may utilize a U.S. DOT stated policy for air passenger hourly value of time. The estimated passenger value of time may be updated if the USDOT stated policy for air passenger hourly value of time is updated. In another embodiment, a value of time for a passenger may be estimated by dividing an annual income of the passenger divided by 2,080 hours per year to obtain an hourly value of time for the passenger.

The estimated value of time for passengers may vary by population or cost of living of the region served by the airport. The estimated value of time for a plurality of passengers may be refined for a flight by slot time, route and day of week for each flight by scaling the value of time by normalized publically available demand elasticity estimates. The estimated value of time for a plurality of passengers may be determined by utilizing data from various sources. The control server 102 may receive the average air passenger value of time from a database, such as the U.S. DOT database. The control server 102 may determine the average number of passengers per flight for each time slot by, for example, retrieving passenger data from a database (e.g., the U.S. DOT BTS load factor statistics) and evaluating a number of passengers indicated for a particular time slot. The control server 102 may receive the number of expected flights sharing each time slot from a database such as the ATAS server 104 or ticket vendor server, for example. The control server 102 may determine the estimated value of time for the plurality of passengers in a time slot. The estimated value of time may be determined by multiplying the average air passenger value of time, the average number of passengers per flight, and each expected flight sharing each time slot.

The control server 102 may determine the congestion delay target based on an estimated value of time for a plurality of passengers. The control server 102 may dynamically receive and update various flight data from multiple servers. This may be advantageous, as the control server 102 may dynamically process and update resulting values, which may lead to greater accuracy in determining values such as an expected congestion delay or an estimated value of time for a plurality of passengers, for example.

A convergence between the estimated value of time for the plurality of passengers and the cost of reducing the congestion delay for increments of time may be used to select the congestion delay target. For example, a value of time of 5000 passengers scheduled for the 40 operations may amount to $190,400 per hour (e.g., if 1000 business passenger have a time value of $60 per hour and 4000 personal passengers have a time value of $32.60 per hour) or $12,693 for 4 minutes. Reducing the congestion delay by 4 minutes (e.g., from 10 minutes to 6 minutes) may require reducing the 40 operations to 39 operations by discontinuing operation of a single small aircraft during the slot, which may cost $12,700. Since the cost of discontinuing operation of the small aircraft achieves a 4-minute congestion delay reduction which is approximately equal to the estimated value of 4 minutes for the passengers during the slot, a congestion delay reduction of 4 minutes may be selected. A convergence between the cost of reducing the congestion delay and the value of time of passengers may be determined by identifying a closest match between the cost of reducing the congestion delay and the value of time of passengers.

In step 540, the congestion control application may determine a utilization level of the slot based on the selected congestion delay target. The utilization level may be a percentage of a maximum capacity of a runway at an airport. The utilization level (e.g., 87% of maximum capacity) may be determined based on a selected congestion delay target (e.g., 6-minute delay). For example, if a maximum capacity of a slot at an airport is 45 scheduled operations and reducing operations to 39 may achieve a determined congestion delay target, a utilization level of 87% (i.e., 39 operations divided by maximum capacity of 45 operation) may be determined.

The control server 102 may determine a utilization level of the time slot based on the congestion target. The control server 102 may utilize the historical congestion delay function (step 452). The control server 102 may recursively evaluate the historical congestion delay function polynomial with a first flight. This may return an estimated amount of time for the flight to taxi including a potential delay. The control server 102 may recursively add flights in a given time slot, and evaluate the flights using the historical congestion delay function polynomial. The utilization level may be determined when the control server 102 finds that the recursively added flights exceeds the threshold of the congestion delay target, and dividing the number of flights by the maximum number of flights possible for a given time slot. The congestion delay target may comprise a predetermined amount of time. The congestion delay target may comprise the minimum congestion delay, as determined in step 454, for example.

In step 550, the congestion control application may determine a congestion premium for one or more flights scheduled during the slot to achieve the determined utilization level. Achieving the determined utilization level may involve, for example, disincentivizing flights during peak slots and/or incentivizing flights during non-peak slots. For example, a premium resulting in a reduction of a flight among flights scheduled for a slot may be the congestion premium. Achieving the determined utilization level may involve, for example, a decrease in ticket selection for flights during a peak slot and/or an increase in ticket selection for flights during a non-peak slot. In an embodiment, the congestion control application may determine a cost of reducing the congestion delay (e.g., the cost of discontinuing operation of one or more flights). For example, the cost of reducing the congestion delay may be the congestion premium.

In an embodiment, the congestion premium may be determined by dynamically receiving and utilizing data from multiple external sources in electrical communication with the control server 102. The control server 102 may receive U.S. DOT average hourly value of air passenger time from a database such as the U.S. DOT BTS, or another known database. The minimum congestion premium may be the average hourly value of air passenger time. The maximum congestion premium may be the minimum congestion premium multiplied by ten. The control server 102 may multiply the average hourly value of passenger time and the expected congestion delay (e.g., step 456) to determine the congestion premium of one or more flights in a time slot.

The congestion premium can be determined by generating an elasticity function derived from ticket acquisition data (e.g., public historical acquisition data and/or acquisition data maintained locally by the system). The elasticity function can mathematically describe a variation of slot utilization resulting from possible congestion premiums. If a target slot utilization is known, a congestion premium corresponding to the target slot utilization can be determined. The elasticity function can be derived specifically for a particular time of day, date, season, arrival airport, destination airport, or any combination thereof. A plurality of elasticity functions can be derived for specific particular scenarios (e.g., flight from La Guardia to Boston Logan at 10:00 am in January, flight from Los Angeles to Seattle at 8 PM on August 22, etc.).

An initial congestion premium may be determined by utilizing a particularized elasticity function derived from route-specific or slot-specific historic data for the airport and/or route. If a route between LaGuardia and Boston Logan has public historic public averages for the average airfare and their elasticity over the day and day of week, then, instead of a nationwide average time-value, a more accurate initial estimate of the initial congestion premium can be computed. For example, if the airfare for a 10:00 am flight from LaGuardia to Boston Logan is $400.00 and the price elasticity is −1.75, and the congestion delay target requires reducing number of seats sold by 25%, then a more accurate estimate for the starting congestion premium would be 0.25×1.75×$400.00=$175.00. This refined estimate still understates the value to passengers, since the current data does not offer insight into the value of reduced congestion or congestionless service. In subsequent seasons, the accuracy of the estimate for the initial value of the congestion premium could be equal to a value of the previous season.

In an embodiment, the congestion control application may receive data associated with a bid for utilizing a slot at an airport. The congestion application may analyze bid data to determine a congestion premium. For example, the bid data may include an index having associations between a plurality of flight operators (e.g., commercial airlines and other aircraft operators) and a bid value for a particular slot. The congestion premium may be iteratively reevaluated. The congestion control application may dynamically update tracked bid data whenever a time slot of an airport receives a predetermined number of quotes for bid data events. The congestion premium may iteratively reevaluate the congestion premium in real-time or in batch mode. The congestion control application may iteratively reevaluate the congestion premium by updating the tracking bid data events upon a predetermined number of quotes received and based on time period in batch mode.

Based on a utilization level determined, a number of flights may be able to utilize the slot to achieve the congestion delay target. For example, 5 flights may be able to operate in the slot to achieve a congestion delay target of a 10-minute delay. A plurality of highest bid values may be determined, and a lowest bid value of the plurality of highest bid values may be selected as the congestion premium. For example, if 5 flights can operate during the slot to achieve the congestion delay target, and the 5 highest bids are $5000, $4950, $4920, $4875, and $4865, the congestion premium of $4865 may be determined. Although some operators may have bid a higher value, the determined congestion premium (e.g., $4865) may be applied to each flight operator for the slot.

In another embodiment, the congestion control application may identify ticket purchase patterns in ticket data to determine the congestion premium. For example, if a 5% decrease in ticket selection is needed to achieve the determined utilization level, a value corresponding to a decrease in ticket selection by 5% may be identified in the ticket data based on historical reductions in ticket selection. If a value of $20 per ticket is determined to decrease ticket selection by 5%, the congestion control application may determine that a congestion premium, for example, of $20,000 for 1000 tickets available during a slot, may achieve the determined utilization level.

In another embodiment, the congestion control application may determine the congestion premium by a two-step process including (1) analyzing bid data and (2) identifying ticket purchase patterns in ticket data. For example, bid data may be analyzed to determine an initial value for a congestion premium. The initial value of for the congestion premium may be determined to be, for example, a lowest value of a plurality of values of bids where a number of the plurality of values is equal to the number of flights determined to be able to utilize the slot to achieve the congestion delay target. For example, if 5 flights are determined to be able to utilize the slot to achieve a 10-minute delay target, then a lowest bid of the top 5 bids may be determined to be an initial congestion premium. The congestion premium may be allocated to a plurality of tickets (as discussed below with reference to step 560) and ticket acquisition data may be obtained from a ticket vendor server indicating a number of tickets sold having the congestion premium. Based on the ticket acquisition data, the congestion control application may reevaluate the congestion premium. The ticket acquisition data may be analyzed to determine whether to a value of the congestion premium may be changed. For example, if a determined selection rate is greater than an expected selection rate, the congestion premium may be increased. In another example, if a determined selection rate is less than an expected selection rate, the congestion premium may be decreased.

In an embodiment, the congestion premium to achieve a utilization level based on a congestion delay target may result in an estimated yield loss. Yield loss may be loss in revenue by the airline or the airport by reducing the number of flights in a time slot. A yield loss function can be derived by smoothing or interpolation of yield loss data for various congestion levels. A passenger time value function can be derived by smoothing or interpolation of estimated passenger time for various congestion levels. A convergence of the yield loss function with the passenger time value function can indicate a point at which the estimated yield loss from reducing the number of flights to achieve a congestion delay target equals the estimated value of air passenger time for each passenger scheduled to use the removed flight. To remove a flight from a time slot, the removed flight may either be displaced or redirected. A displaced flight may be canceled from the time slot. A redirected flight may comprise a flight moved from a peak time to an off-peak time slot. A flight may be redirected or displaced to allow the time slot to meet a congestion delay target value.

The congestion control application may determine an initial value of a congestion premium. The congestion premium may be further dictated by iterative changes in vendor data. Iterative changes in vendor data can indicate a shift in flights from peak time slot flights to off-peak time slots.

In step 560, the congestion control application may update a premium schedule database to allocate the congestion premium among tickets for one or more flights scheduled during the slot. The premium schedule database may be part of a control server, as described with reference to FIG. 2. The congestion premium may be allocated among, for example, operators of one or more flights and/or tickets for one or more flights scheduled during the slot. For example, if 5 flights are scheduled for a slot, a congestion premium of $5000 may be charged to an operator (e.g., a cargo delivery company) of one flight (e.g., a cargo aircraft) and allocated among tickets for the other 4 flights (e.g., passenger aircraft). Allocating the congestion premium among tickets may involve splitting the congestion premium evenly or distributing based on one or more variables (e.g., ticket price, ticket type, aircraft type, aircraft takeoff time requirement, aircraft landing time requirement, etc.). For example, the congestion premium may be allocated proportionally based on ticket price. In another example, the congestion premium may be allocated based on an aircraft takeoff time requirement, where tickets for an aircraft requiring a longer takeoff time may be allocated a proportionally larger portion of the congestion premium. The congestion premium may be provided to a ticket vendor server. The congestion premium may be provided to a user device.

FIGS. 6A-6B are a flow diagram illustrating another sample process for managing air traffic data, according to various embodiments. The sample process of FIG. 5 may involve an iterative process for determining a congestion premium, based on air traffic data and periodically updated ticket data, designed to reduce a congestion delay for a slot of an airport. The iterative process for determining a congestion premium may include, for example, obtaining air traffic data from an air traffic activity system server (step 600), storing the air traffic data into an air traffic database (e.g., air traffic database 210) within the control server (step 605), querying an air traffic database for air traffic data of an airport (step 610), determining, based on the air traffic data, a congestion delay resulting from the number of flights utilizing the slot of the airport (step 620), estimating a value of time for a plurality of expected passengers of the number of flights (step 625), selecting a congestion delay target based on the estimated time value of a plurality of passengers (step 630), determining a utilization level of the slot based on the selected congestion delay target (step 640), determining a congestion premium for one or more flights scheduled during the slot to achieve the defined utilization level (step 650), updating a premium schedule database to allocate the congestion premium among tickets for one or more flights scheduled during the slot (step 660), providing the congestion premium allocated among tickets for the one or more flights scheduled during the slot to a ticket vendor server (step 665), obtaining ticket acquisition data over a time period from the ticket vendor server (step 670), reevaluating the congestion premium for the one or more flights scheduled during the slot based on the ticket acquisition data over the time period (step 680), and updating the premium schedule database with the reevaluated congestion premium (step 690). Various embodiments for determining a congestion premium to reduce a congestion delay are discussed below.

In step 600, the congestion control application of the control server may obtain air traffic data from an air traffic activity system (ATAS) server. The air traffic data may include schedules of a number of flights utilizing a plurality of slots of a plurality of airports. A slot is a period of time for an aircraft to take-off or land at the airport.

The control server may obtain air traffic data from the ATAS server by transmitting a message to the ATAS server including a query for the air traffic data. In response to the message, the ATAS server may transmit the air traffic data to the control server. The control server may receive the air traffic data from the ATAS server. The control server may identify the received data as air traffic data by, for example, recognizing a host identification of the ATAS server and/or a data structure of the received data. Received data identified as air traffic data may be stored in an air traffic database, as discussed below with reference to step 605.

In step 605, the congestion control application of the control server may store the air traffic data into an air traffic database (e.g., air traffic database 210) within the control server. The air traffic database may be a memory device (or a portion of a memory device) of the control server configured to store the air traffic data. The air traffic database may be electrically connected to a processor of the control server such that the processor may query the air traffic database.

In step 610, the congestion control application may query an air traffic database for air traffic data of an airport. The air traffic data may include schedules of a number of flights utilizing a slot of the airport. Various embodiments for querying the air traffic database are discussed with reference to step 510 in FIG. 5.

In step 620, the congestion control application may determine, based on the air traffic data, a congestion delay resulting from the number of flights utilizing the slot of the airport. Various embodiments for determining the congestion delay are discussed with reference to step 520 in FIG. 5.

In step 625, the congestion control application may estimate a value of time for a plurality of expected passengers of the number of flights. Estimating a value for passenger time may be based on one or more variables such as, for example, trip purpose (e.g., business or personal travel), identified characteristics of passenger (e.g., age, sex, education, employment, income, etc.), distance of travel, and ticket type (e.g., economy, business, first class, etc.). Various embodiments for estimating a value for passenger time are discussed below. Some embodiments may determine different values for different passengers. Some embodiments may estimate a same value for one or more passengers based on one or more common variables shared between the passengers.

In an embodiment, the value of time for a passenger may be estimated to be the same as the value of travel time savings (VTTS) determined by the United States Department of Transportation (USDOT). Data associated with the VTTS may be obtained from a USDOT server via the control server 102. VTTS may vary depending on one or more other variables. For example, VTTS for a trip purpose defined as “business” may be $60.00 per hour. In another example, VTTS for a trip purpose defined as “personal” may be $32.60 per hour. Embodiments include assuming an annual rate of growth of 1.2 percent of real median household income to determine an increase in VTTS in any given year.

In an embodiment, a value of time for a passenger may be estimated by dividing an annual income of the passenger divided by 2,080 hours per year to obtain an hourly value of time for the passenger. Annual income of a passenger may be extracted from the ticket database 230 (e.g., $100,000 per year). The extracted annual income of $100,000 per year may be divided by 2,080 hours to obtain an estimated hourly value of time for the passenger of $48.08. In an embodiment, if income data is not available for a passenger, a default annual income value may be used. The default annual income value may be the median annual of airline travelers. For example, the median annual income of airline travelers in a given year (e.g., $70,000) may be divided by 2,080 hours to obtain an estimated hourly value of time for the passenger of $33.65. If data of a current year median annual income is not available, data associated with a prior year median annual income may be used and an annual rate of growth of 1.2 percent for median annual income may be assumed.

In step 630, the congestion control application may select a congestion delay target based on an estimated time value of a plurality of customers. Various embodiments for selecting the congestion delay target are discussed with reference to step 530 in FIG. 5.

In step 640, the congestion control application may determine a utilization level of the slot based on the selected congestion delay target. Various embodiments for determining the utilization level are discussed with reference to step 540 in FIG. 5.

In step 650, the congestion control application may determine a congestion premium for one or more flights scheduled during the slot to achieve the defined utilization level. The congestion control application may determine the congestion premium based on, for example, bid data associated with one or more flight operators and/or ticket acquisition data. Determining the congestion premium may be an iterative process involving receiving updated bid data and/or updated ticket acquisition data to reevaluate the congestion premium. Various embodiments for determining the congestion premium for the one or more flights are discussed with reference to step 550 in FIG. 5.

In step 660, the congestion control application may update a premium schedule database with the congestion premium determined in step 650. The premium schedule database may be located within the control server. The premium schedule database may be updated by a processor within the control server. The congestion premium may be allocated among, for example, operators of one or more flights and/or tickets for one or more flights scheduled during the slot. For example, if 5 flights are scheduled for a slot, a congestion premium of $5000 may be charged to an operator (e.g., a cargo delivery company) of one flight (e.g., a cargo aircraft) and allocated among tickets for the other 4 flights (e.g., passenger aircraft). The congestion premium may be allocated evenly or unevenly among the operators and/or tickets. For example, the congestion premium may be divided evenly among a plurality of tickets of flights scheduled during a slot. In another example, one or more variables (e.g., ticket price, ticket type, takeoff time of aircraft, aircraft type, flight duration, etc.) may be used to allocate the congestion premium proportionally based on the one or more variables. Tickets for flights having a longer takeoff time may be allocated a larger portion of the congestion premium since the longer takeoff time may cause more of a delay than a flight having a shorter takeoff time. A larger time gap between flights may be required for larger aircraft due to a larger wake created by large aircraft compared to small aircraft. A larger portion of the congestion premium may be allocated to tickets for large aircraft to account for a large wait time required after takeoff of a large aircraft.

In step 665, the congestion control application may provide the congestion premium allocated among tickets for the one or more flights scheduled during the slot to a ticket vendor server. The congestion premium allocated among tickets for the one or more flights may be transmitted electronically by the control server to the ticket vendor server. The ticket vendor server may provide tickets and the allocated congestion premium to a user device. One or more users of one or more user devices may select tickets having the allocated congestion premium over a period of time (e.g., an hour, several hours, a day, etc.). Data associated with selected tickets having the allocated congestion premium may be stored in the ticket vendor server. The ticket acquisition data (i.e. data associated with selected tickets having the allocated congestion premium) may be obtained by the control server, as discussed below with reference to step 670.

In step 670, the congestion control application may obtain ticket acquisition data over a time period from the ticket vendor server. The time period may a period of time (e.g., an hour, day, etc.) subsequent to providing the allocated congestion premium to the ticket vendor server. The ticket acquisition data may be obtained by transmitting a message to the ticket vendor server including a query for ticket acquisition data. The ticket vendor server may transmit the ticket acquisition data to the control server. The control server may identify the received data as ticket acquisition data by, for example, examining a host identification of the transmitting device and/or a data structure of the received data. The obtained ticket acquisition data may be used to reevaluate the congestion premium, as discussed below with reference to step 680.

In step 680, the congestion control application may reevaluate the congestion premium for the one or more flights scheduled during the slot based on the ticket acquisition data over the time period. The ticket acquisition data may be analyzed to determine a selection rate for tickets associated with a flight. If a determined selection rate is greater than an expected selection rate, the congestion premium may be increased. If a determined selection rate is less than an expected selection rate, the congestion premium may be decreased.

In step 690, the congestion control application may update the premium schedule database with the reevaluated congestion premium. Updating the premium schedule database may include storing the reevaluated congestion premium in the premium schedule database.

The reevaluated congestion premium may be allocated among tickets for one or more flights. The allocated reevaluated congestion premium may be provided to the ticket vendor server. Steps 665, 670, 680, and 690 may be repeated if a difference between a determined selection rate exceeds an expected selection rate by a threshold value, such as, for example, one standard deviation, two standard deviations, or any fraction of a standard deviation.

While processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

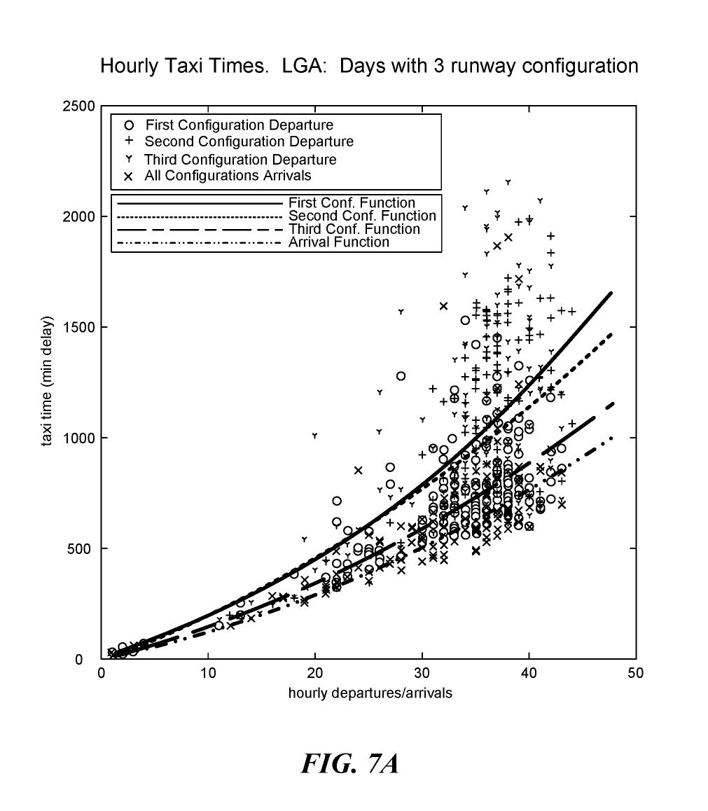

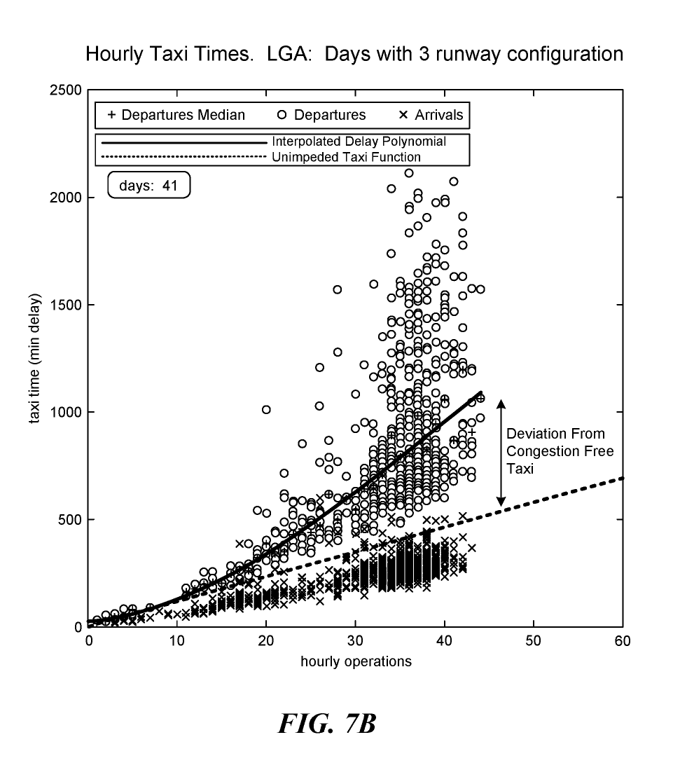

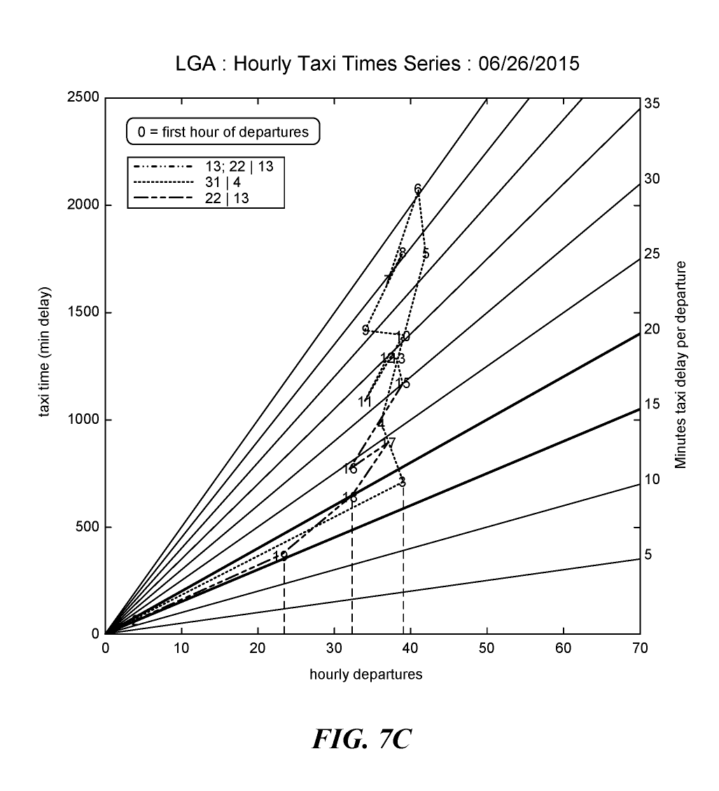

FIG. 7A illustrates taxi time functions for a runway having three configurations, according to various embodiments. An airport can have one or more configurations. For example, La Guardia Airport (LGA) operates in three typical configurations that re-route aircraft operations (e.g., takeoff and landing) to different runways. Different configurations can result in different congestion even with the same number of flight operations in a slot. Predicting an airport configuration for a slot can greatly increase accuracy of likely congestion from a number of flight operations scheduled during the slot.

FIG. 7B illustrates a deviation between a taxi time function and an unimpeded (congestion free) function, according to various embodiments. A weighted average of samples taxi times across a plurality of days having no identified delay other than excess volume (e.g., no identified weather event). The unimpeded function (shown as a dashed line) is determined by analyzing arrival samples above a minimum departure delay within a corresponding time period (e.g., within a same time period or within a threshold time differential). The unimpeded function can be mapped onto a region where arrival samples begin to encroach upon departure samples. Arrival samples typically taxi directly to a gate and thus typically represent a quickest possible taxi for a given airport. In contrast, departure samples may indicate that a waiting period occurred due to excess volume. The taxi time function indicates when the delay polynomial derived from daily operations deviates from a linear projection of the unimpeded (congestion free) taxi rate and a number of flights beyond a pre-defined threshold.

FIG. 7C is a line chart illustrating congestion delay predicted by the taxi time functions for a runway having three configurations by utilizing a time series method, according to various embodiments. A time series is a series of data points indexed (or listed or graphed) in time order. The time series can include a sequence taken at successive equally spaced points in time (e.g. 1 hour slots). The time series is plotted on the line chart shown.

Time series analysis can be performed by either of auto-correlation and/or cross-correlation analysis. Autocorrelation analysis can be employed to identify serial dependence. A time series of a slot can have serial dependence if the slot at some time in the series is statistically dependent on the slot at another time. A series is serially independent if there is no dependence between any pair.

The time series analysis technique can include parametric or non-parametric methods. The parametric approach can assume that the underlying stationary stochastic process has a certain structure which can be described using a small number of parameters (for example, using an autoregressive or moving average model). The parameters of the model can be estimated to describe the stochastic process. A non-parametric approach can explicitly estimate the covariance or the spectrum of the process without assuming that the process has any particular structure. The time series analysis can be linear or non-linear, and univariate or multivariate.

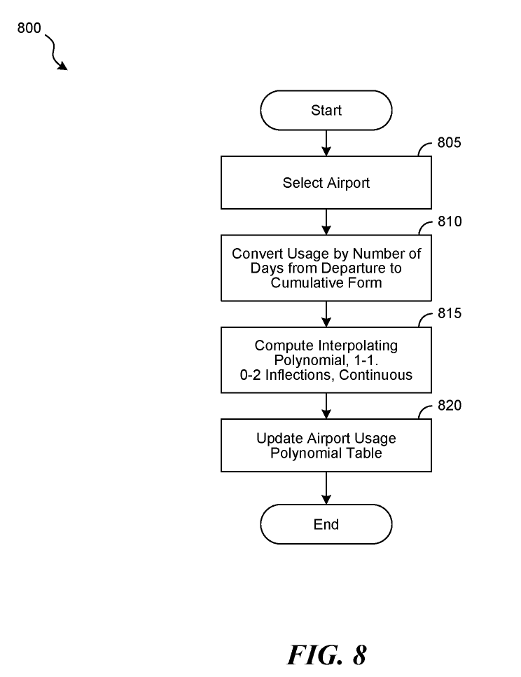

FIG. 8 is a flow diagram illustrating a sample process 800 for computing airport usage functions (e.g., polynomial functions), according to various embodiments. The process for computing airport usage polynomials can include selecting an airport (e.g., manually or in response to another action) (805). Daily usage metrics for the selected airport can be retrieved from a usage metrics library (e.g., within a database). A mean usage and/or a weighted average of usage is determined. The mean and/or weighted average usage is converted to a cumulative form according to a number of days of usage (810). Interpolating polynomial, 1-1, 0-2 Inflections, and continuity is computed (815). An airport usage polynomial table is updated according to the computed interpolating polynomial (820).

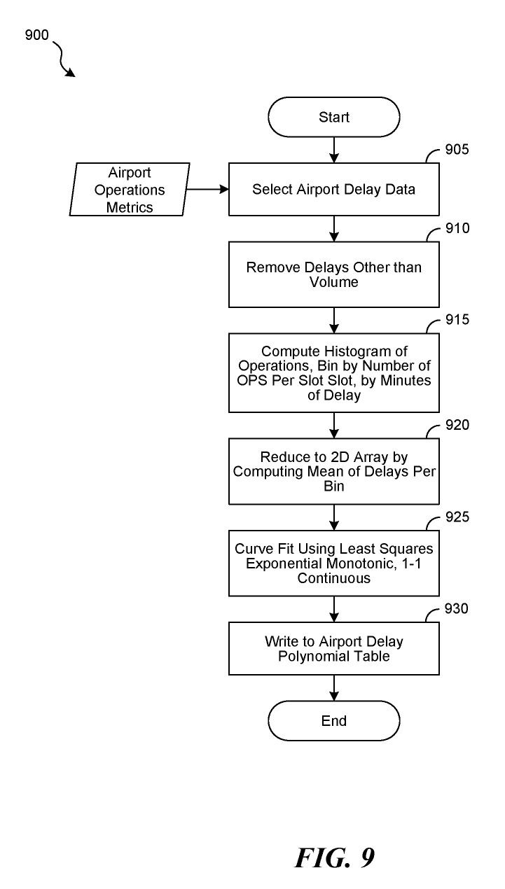

FIG. 9 is a flow diagram illustrating a sample process 900 for generating airport delay polynomial tables, according to various embodiments. An airport delay polynomial update query can be received and an airport can be selected (e.g., manually or in response to another action) (905). Upon receiving the query and airport selection, airport operation metrics can be retrieved from an operation metrics library (e.g., within a database). Taxi samples associated with a cause label other than a volume label (e.g., a weather label) can be removed (910). A histogram of operations can be generated and binned by number of operations per slot and minutes of delay (915). The computed histogram of operations can be reduced to a two-dimensional array by computing a mean and/or weighted average of delays per bin (920). A curve fit can be generated by employing a least squares monotonic, 1-1 continuous method (925). The curve fit can generate a delay polynomial. The delay polynomial can be written to the airport delay polynomial table (930).

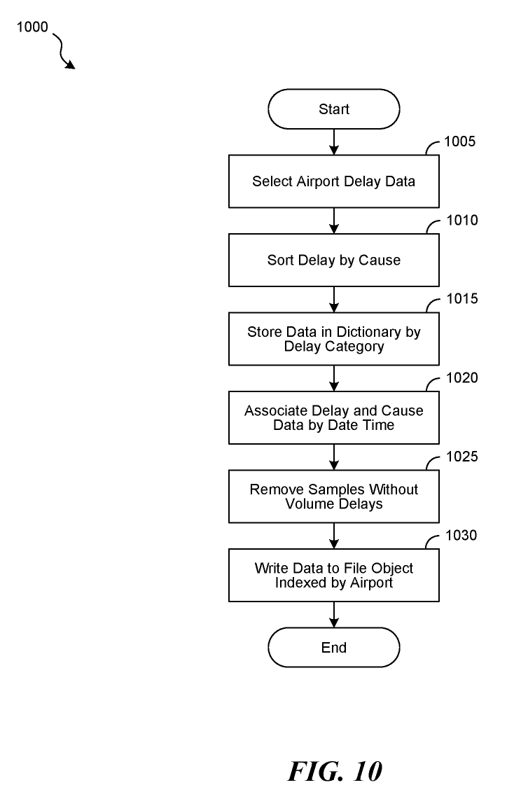

FIG. 10 is a flow diagram illustrating a sample process 1000 for extracting delay data (e.g., taxi time data) associated with a cause category, according to various embodiments. The system can extract delay data associated with a cause label (e.g., volume caused delay). For example, the system can analyze and label delay causes for delay data (e.g., including taxi times associated with aircraft operations) associated with an airport. Cause tables having corresponding time stamps with delay data can be generated and sorted by cause labels (1010). Delay data can be stored by delay category (1015). The cause tables can be populated with probabilities corresponding to each of a plurality of cause labels. If a weather event (e.g., snow storm) is associated with a time stamp corresponding to a slot time, a high probability is generated for the cause label corresponding to weather event for the slot time(s) in which the weather event occurred. If a probability above a threshold (e.g., above 50%) is associated with an event other than high volume, a cause label associated with the non-volume event can be presumed to be dominant. Cause data can be associated with delay data according to corresponding time stamps (1020). Delay data associated with cause data having a threshold association with a non-volume event can be removed (1025). Associations between delay duration data and delay cause data can be written to a file object and indexed by airport (1030).

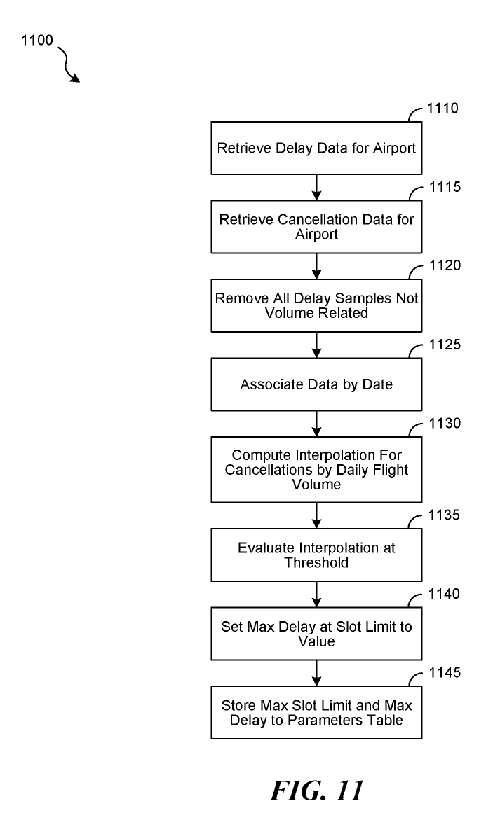

FIG. 11 is a flow diagram illustrating a sample process 1100 for computing a maximum slot limit, according to various embodiments. The maximum slot limit can be computed by retrieving flight delay data (e.g., including taxi times associated with aircraft operations) associated with an airport (1110), retrieving cancellation data for the airport (1115), removing delay samples not associated with volume delays (1120), joining cause data with delay data according to date (1125), computing interpolation for cancellations by daily flight volume (1130), evaluating interpolation at a threshold interpolation value (1135), setting a maximum delay and maximum slot limit to a value (1140), and storing the maximum delay and maximum slot limit to a parameters table (1145).

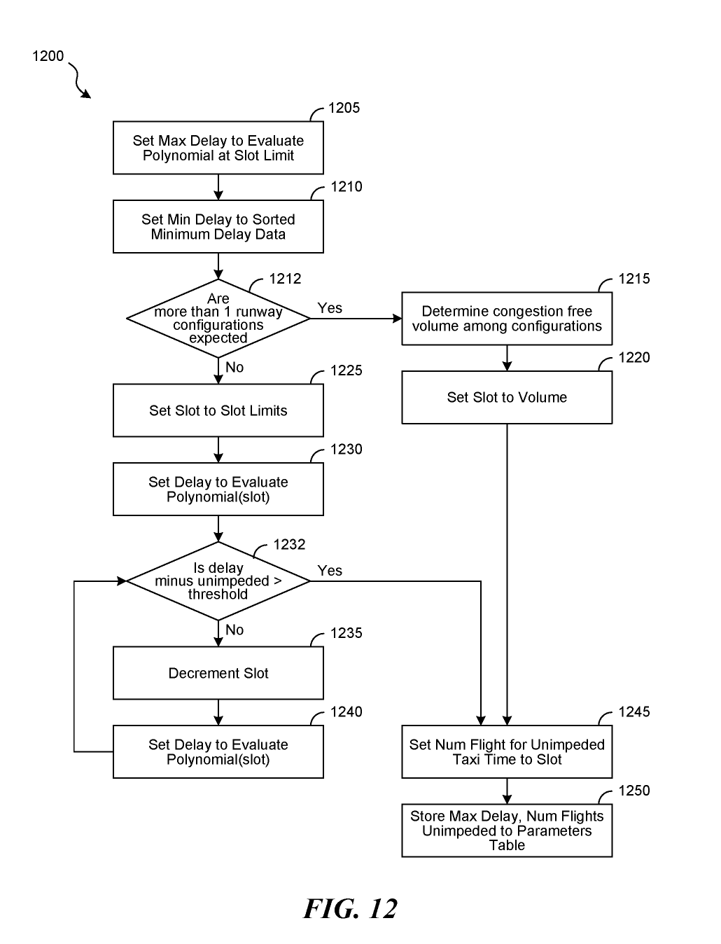

FIG. 12 is a flow diagram illustrating a sample process 1200 for computing limits for a delay function, according to various embodiments. The system can set a maximum delay to evaluate a function (e.g., a polynomial function) at a particular slot limit (1205). The minimum delay can be set according to sorted minimum delay data (1210). Minimum delay data can include minimum taxi times associated with aircraft operations. The system can determine whether there are more than one runway configurations expected at the airport (1212).

If there is more than one runway configuration expected at the airport (1212—Yes), the system calculates a congestion free volume among the configurations (1215). The system sets the slot to a target volume (1220). The set number of flights for unimpeded taxi time is determined (1245). The maximum delay and number of flights is stored to a parameters table (1250).

If there is not more than one runway configuration expected at the airport (1212—No), the system sets the slot to a target volume (1225). The system sets a delay to evaluate a polynomial function for the slot (1230). The system determines whether a differential between delay and unimpeded taxi exceeds a threshold value (1232).

If the differential between delay and the unimpeded taxi exceeds the threshold value (1232—Yes), the set number of flights for unimpeded taxi time is determined (1245). The maximum delay and number of flights is stored to a parameters table (1250).

If the differential between delay and the unimpeded taxi does not exceed the threshold value (1232—No), the slot is decremented (1235). The delay is reset to evaluate a polynomial function for the reset slot (1240). The system re-determines whether a differential between delay and unimpeded taxi exceeds a threshold value (1232). This process can repeat until the differential between delay and the unimpeded taxi exceeds the threshold value.

### Computer

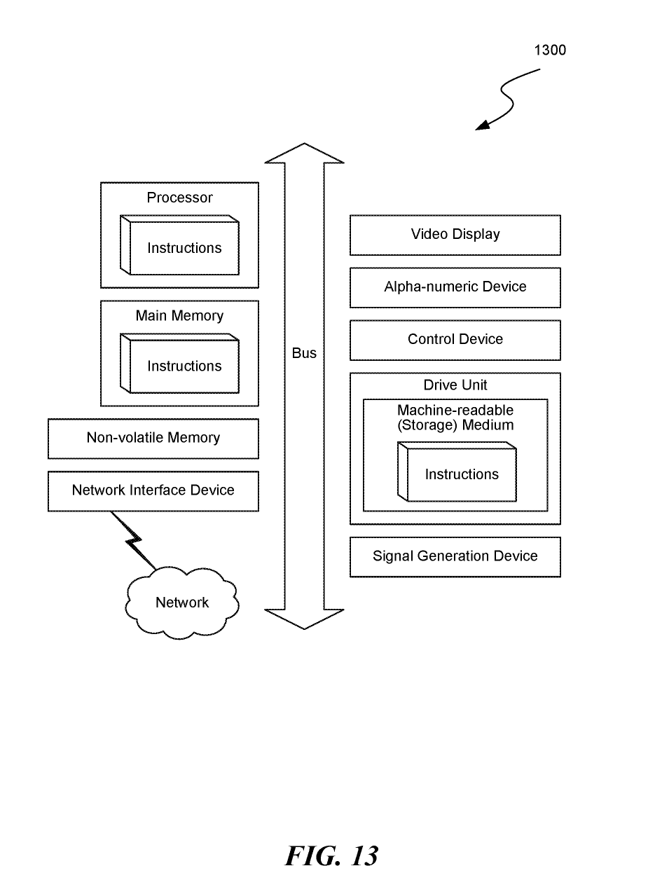

FIG. 13 is a diagrammatic representation of a machine in the example form of a computer system 1300 within which a set of instructions, for causing the machine to perform any one or more of the methodologies or modules discussed herein, may be executed. For example, the computer system 1300 may implement with the congestion server 102, the ATAS server 104, the ticket vendor server 106, and/or the user device 302.

In the example of FIG. 13, the computer system 1300 includes a processor, memory, non-volatile memory, and an interface device. Various common components (e.g., cache memory) are omitted for illustrative simplicity. The computer system 1300 is intended to illustrate a hardware device on which any of the components described in the example of FIGS. 1-12 (and any other components described in this specification) may be implemented. The computer system 1300 may be of any applicable known or convenient type. The components of the computer system 1300 may be coupled together via a bus or through some other known or convenient device.

This disclosure contemplates the computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1300 may include one or more computing devices be unitary or distributed; span multiple locations; span multiple machines; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

The processor may be, for example, a conventional microprocessor such as an Intel Pentium microprocessor or Motorola PowerPC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory may include, by way of example but not limitation, random access memory (RAM), such as dynamic RAM (DRAM) and static RAM (SRAM). The memory may be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer system 1300. The non-volatile storage may be local, remote, or distributed. The non-volatile memory is optional because systems may be created with all applicable data available in memory. A typical computer system will usually include at least a processor, memory, and a device (e.g., a bus) coupling the memory to the processor.

Software is typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface may include one or more of a modem or network interface. It will be appreciated that a modem or network interface may be considered to be part of the computer system 1300. The interface may include an analog modem, ISDN modem, cable modem, token ring interface, satellite transmission interface (e.g., “direct PC”), or other interfaces for coupling a computer system to other computer systems. The interface may include one or more input and/or output devices. The I/O devices may include, by way of example but not limitation, a keyboard, a mouse or other pointing device, disk drives, printers, and other input and/or output devices, including a display device. The display device may include, by way of example but not limitation, a cathode ray tube (CRT), liquid crystal display (LCD), or some other applicable known or convenient display device. For simplicity, it is assumed that controllers of any devices not depicted in the example of FIG. 13 reside in the interface.

In operation, the computer system 1300 may be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments may be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. Accordingly, the disclosure of various embodiments is intended to be illustrative, but not limiting, of the scope of the embodiments, which is set forth in the following claims.

1. A method for managing air traffic data comprising:
retrieving a first dataset from a first server and a second dataset from a second server, the first dataset being indicative of scheduled flights for slots of an airport, the second dataset being indicative of tickets available for one or more flights, wherein a slot is a period of time for an aircraft operation associated with a specific runway or taxiway of the airport;
generating an integrated dataset by associating portions of each of the first and second datasets indicative of a time period within a threshold range of the slots;
generating a congestion delay function for at least one airport configuration by identifying and eliminating taxi time data within the integrated dataset associated with a cause label other than a volume label, and utilizing regression analysis for taxi time data within the integrated dataset associated with the volume label, wherein the congestion delay function deviates from an unimpeded taxi function;
predicting a congestion delay for a particular slot employing the congestion delay function and performing a time series analysis on the integrated data, wherein the predicted congestion delay deviates from the unimpeded taxi function; and
selecting a congestion delay target for the particular slot having a deviation less than the predicted congestion delay from the unimpeded taxi function, wherein the congestion delay target is selected within a pre-determined range of a convergence between an estimated yield loss from reducing the scheduled flights for the particular slot and an estimated value of time for a plurality of passengers.

2. The method of claim 1, further comprising:
predicting an airport configuration for the particular slot based on a historical runway configuration, predicted runway configuration of another airport during the particular slot, a time, a date, a predicted weather condition, or any combination thereof.

3. The method of claim 1, further comprising:
generating the unimpeded taxi function by analyzing arrival samples above minimum departure samples within corresponding time periods.

4. The method of claim 1, wherein determining the congestion delay function comprises determining a residual delay resulting from flights scheduled in previous slots.

5. The method of claim 1, wherein eliminating taxi time data within the integrated dataset associated with a cause label other than the volume label comprises:
extracting taxi time data from an operation metrics library of the integrated dataset; and
generate associations between the delay data and cause tables having corresponding time stamps, wherein the cause tables include a probability corresponding to each of a plurality of cause labels for each time stamp, wherein associations are generated if a probability of a cause label exceeds a threshold.

6. The method of claim 1, wherein the utilization level is a percentage of a maximum capacity for the particular slot.

7. The method of claim 1, further comprising:
obtaining, from the second server, ticket acquisition data over a time period;
calculating a congestion premium for the one or more flights scheduled during the particular slot based on the ticket acquisition data over the time period; and
updating a premium schedule database with the calculated congestion premium.

8. The method of claim 1, wherein the first server is an air traffic server and the second server is a ticket vendor server.

9. The method of claim 1, wherein the aircraft operation is a takeoff or a landing.

10. The method of claim 11, further comprising:
iteratively performing the following:
obtaining, from the second server, ticket acquisition data over a time period;
determining, based on the ticket acquisition data, a selection rate of tickets having an allocated congestion premium; and
performing either of the following:
in response to determining that a difference between the determined selection rate and an expected selection rate exceeds a threshold, reevaluating the congestion premium for the one or more flights scheduled during the particular slot based on the ticket acquisition data over the time period, and providing the reevaluated congestion premium to the ticket vendor server; or
in response to determining that the difference between the determined selection rate and an expected selection rate does not exceed a threshold, terminating iteration of said iteratively performing.

11. The method of claim 1, further comprising:
determining a congestion premium for one or more flights scheduled during the particular slot according to the determined utilization level by employing an elasticity function derived from historical ticket acquisition data; and
updating a premium schedule database to allocate the congestion premium among tickets for the one or more flights scheduled during the particular slot.

12. The method of claim 11, further comprising:
updating the premium schedule database to allocate the congestion premium among one or more operators of the one or more flights scheduled during the particular slot.

13. The method of claim 12, wherein determining the congestion premium comprises iteratively reevaluating the congestion premium based on ticket acquisition data.

14. The method of claim 1, wherein performing a time series analysis on the integrated data comprises:
evaluating a sequence of slots of the airport indexed in time order by either of auto-correlation and/or cross-correlation analysis;
determining if any of the slots among the series of slots are serially dependent and/or statically dependent with respect to any other slot among the series of slots;
upon determining that any of the slots are serially dependent with respect to another slot, updating an increment among slots to account for the dependence.

15. A method for managing air traffic data comprising:
retrieving a first dataset from a first server and a second dataset from a second server, the first dataset being indicative of scheduled flights for slots of an airport, and the second dataset being indicative of tickets available for one or more flights;
generating a congestion delay function for a plurality of airport configurations by identifying and eliminating taxi time data within the first and second dataset associated with a cause label other than a volume label, and utilizing regression analysis for taxi time data within the first and second dataset associated with the volume label;
predicting an airport configuration among the plurality of airport configurations for a particular slot based on a historical runway configuration, predicted configuration of another airport during the particular slot, a time, a date, a predicted weather condition, or any combination thereof;
predicting a congestion delay for the particular slot by employing the congestion delay function and performing a time series analysis on the first and second dataset, wherein the predicted congestion delay deviates from an unimpeded taxi function; and
selecting a congestion delay target for the particular slot having a deviation less than the predicted congestion delay from the unimpeded taxi function, wherein the congestion delay target is selected within a pre-determined range of a convergence between an estimated yield loss from reducing the scheduled flights for the particular slot and an estimated value of time for a plurality of passengers.

16. The method of claim 15, further comprising:
iteratively reevaluating the predicted airport configuration in response to an updated predicted configuration of another airport during the particular slot and/or an updated predicted whether condition.

17. The method of claim 15, wherein eliminating taxi time data within the integrated dataset associated with a cause label other than the volume label comprises:
extracting taxi time data from an operation metrics library of the integrated dataset; and
generate associations between the delay data and cause tables having corresponding time stamps, wherein the cause tables include a probability corresponding to each of a plurality of cause labels for each time stamp, wherein associations are generated if a probability of a cause label exceeds a threshold.

18. The method of claim 17, further comprising:
obtaining, from the second server, ticket acquisition data over a time period;
calculating a congestion premium for the one or more flights scheduled during the particular slot based on the ticket acquisition data over the time period; and
updating a premium schedule database with the calculated congestion premium.

19. The method of claim 15, further comprising:
iteratively performing the following:
obtaining, from the second server, ticket acquisition data over a time period;
determining, based on the ticket acquisition data, a selection rate of tickets having an allocated congestion premium; and
performing either of the following:
in response to determining that a difference between the determined selection rate and an expected selection rate exceeds a threshold, reevaluating the congestion premium for the one or more flights scheduled during the particular slot based on the ticket acquisition data over the time period, and providing the reevaluated congestion premium to the ticket vendor server; or
in response to determining that the difference between the determined selection rate and an expected selection rate does not exceed a threshold, terminating iteration of said iteratively performing.

20. An integrated management system comprising:
a server having a processor and a tangible storage device;
an interface of the server including communication protocols compatible with an air traffic server and a ticket vendor server, the interface configured to retrieve a first dataset from the air traffic server and a second dataset from the ticket vendor server, the first dataset being indicative of scheduled flights for slots of an airport, the second dataset being indicative of tickets available for one or more flights, wherein a slot is a period of time for an aircraft operation associated with a specific runway or taxiway of the airport; and
program instructions embodied on the tangible storage device for execution by the processor, the program instructions configured to cause the processor to perform a method comprising:
generating an integrated dataset by associating portions of each of the first and second datasets indicative of a time period within a threshold range of the slots of the airport;
generating a congestion delay function for at least one airport configuration by identifying and eliminating taxi time data within the integrated dataset associated with a cause label other than a volume label, and utilizing regression analysis for taxi time data within the integrated dataset associated with the volume label, wherein the congestion delay function deviates from an unimpeded taxi function;
predicting a congestion delay for a particular slot employing the congestion delay function and performing a time series analysis on the integrated data, wherein the predicted congestion delay deviates from the unimpeded taxi function;
selecting a congestion delay target for the particular slot having a deviation less than the predicted congestion delay from the unimpeded taxi function, wherein the congestion delay target is selected within a pre-determined range of a convergence between an estimated yield loss from reducing scheduled flights for the particular slot and an estimated value of time for a plurality of passengers.

21. The integrated management system of claim 20, the method further comprising:
predicting an airport configuration for the particular slot based on a historical runway configuration, predicted runway configuration of another airport during the particular slot, a time, a date, a predicted weather condition, or any combination thereof.

22. The integrated management system of claim 20, the method further comprising:
generating the unimpeded taxi function by analyzing arrival samples above minimum departure samples within corresponding time periods.

23. The integrated management system of claim 20, wherein eliminating taxi time data within the integrated dataset associated with a cause label other than the volume label comprises:
extracting taxi time data from an operation metrics library of the integrated dataset; and
generate associations between the delay data and cause tables having corresponding time stamps, wherein the cause tables include a probability corresponding to each of a plurality of cause labels for each time stamp, wherein associations are generated if a probability of a cause label exceeds a threshold.

24. The method of claim 1, further comprising:
dynamically assigning excess volume during the particular slot to one or more other slots, the excess volume determined based on the selected congestion delay target for the particular slot.

25. The method of claim 1, further comprising:
dynamically setting an operation volume during the particular slot to less than a number of scheduled flights corresponding to the congestion delay target.
